(19) United States
(12) Patent Application Publication
(10) Pub. No.: US 2026/0237140 A1
(43) Pub. Date: Aug. 13, 2026

(54) INFORMATION PROCESSING SYSTEM, SERVER, AND NON-TRANSITORY RECORDING MEDIUM

(71) Applicant: Naoki MOTOHASHI, Kanagawa (JP)

(72) Inventor: Naoki MOTOHASHI, Kanagawa (JP)

(21) Appl. No.: 19/454,387

(22) Filed: Jan. 21, 2026

(30) Foreign Application Priority Data
Feb. 10, 2025 (JP) 2025-019940

(51) Int. Cl. G06T 15/00

(52) U.S. Cl. CPC G06T 15/00

(57) ABSTRACT

An information processing system includes a terminal device that displays a first display screen including speech text being received from a first server during a session established between the terminal device and the first server, the three-dimensional image information and a captured image being received from a second server during a session established between the terminal device and the second server in a case where the terminal device has established a session with the first server, and displays a second display screen including the three-dimensional image information and the captured image received from the second server during a session established between the terminal device and the second server. The second circuitry performs processing based on the three-dimensional image information and input information received through the first display screen or the second display screen.

### CROSS-REFERENCE TO RELATED APPLICATION

This patent application is based on and claims priority pursuant to 35 U.S.C. § 119(a) to Japanese Patent Application No. 2025-019940, filed on Feb. 10, 2025, in the Japan Patent Office, the entire disclosure of which is hereby incorporated by reference herein.

### BACKGROUND

### Technical Field

The present disclosure relates to an information processing system, a server, and a non-transitory recording medium.

### Related Art

In some cases, a first server and a second server each manage related information. In this case, there is a technique for allowing information managed by the first server and information managed by the second server to be displayed on a terminal device.

### SUMMARY

The present disclosure described herein provides an information processing system including: a first server including first circuitry that manages speech text based on audio data obtained with a captured image of a target object; a second server including second circuitry that manages three-dimensional image information of the target object and the captured image that is aligned in position with the three-dimensional image information; and a terminal device communicable with the first server and the second server. The terminal device includes terminal circuitry to: display a first display screen on a display, the first display screen including the speech text, the three-dimensional image information, and the captured image, the speech text being received from the first server during a session established between the terminal device and the first server, the three-dimensional image information and the captured image being received from the second server during a session established between the terminal device and the second server in a case where the terminal device has established a session with the first server; and display a second display screen on the display, the second display screen including the three-dimensional image information and the captured image, the three-dimensional image information and the captured image being received from the second server during a session established between the terminal device and the second server. The second circuitry performs processing based on the three-dimensional image information and input information received by the terminal device through the first display screen or the second display screen.

The present disclosure described herein provides a second server communicable with a terminal device and a first server that manages speech text based on audio data obtained with a captured image of a target object. The second server includes circuitry that: manages three-dimensional image information of the target object and the captured image that is aligned in position with the three-dimensional image information; and performs processing based on the three-dimensional image information and input information received by the terminal device through a first display screen or a second display screen. The first display screen includes the speech text, the three-dimensional image information, and the captured image, the speech text being received by the terminal device from the first server during a session established with the first server. The three-dimensional image information and the captured image are received by the terminal device from the second server during a session established with the second server in a case where the terminal device has established a session with the first server. The second display screen includes the three-dimensional image information and the captured image. The three-dimensional image information and the captured image are received by the terminal device from the second server during a session established with the second server.

The present disclosure described herein provides a non-transitory recording medium storing a plurality of instructions which, when executed by one or more processors on a second server communicably connected with a terminal device and a first server, causes the one or more processors to perform an information processing method including: managing three-dimensional image information of a target object and a captured image of the target object, the captured image being aligned in position with the three-dimensional image information; and performing processing based on the three-dimensional image information and input information received by the terminal device through a first display screen or a second display screen. The first display screen includes speech text, the three-dimensional image information, and the captured image. The speech text is received by the terminal device from the first server during a session established with the first server, the speech text being based on audio data obtained with the captured image. The three-dimensional image information and the captured image are received by the terminal device from the second server during a session established with the second server in a case where the terminal device has established a session with the first server. The second display screen includes the three-dimensional image information and the captured image. The three-dimensional image information and the captured image are received by the terminal device from the second server during a session established with the second server.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a general arrangement of an example of an information processing system;

FIG. 2 is a diagram illustrating a hardware configuration of an example of an image management server, a conference management server, and a terminal device;

FIG. 3 is a diagram illustrating a functional configuration of an example of functions of the image management server, the conference management server, and the terminal device in the information processing system;

FIG. 4 is an illustration of an example of a three-dimensional image information management table;

FIG. 5 is an illustration of an example of a captured image information management table;

FIG. 6 is an illustration of an example of a conference information management table;

FIG. 7 is a sequence diagram illustrating an example of a process of communicating a wide-view image and audio data;

FIGS. 8A and 8B are diagrams illustrating an example of screens displayed on the terminal device in the model update process and the text information generation process, respectively;

FIGS. 9A and 9B are diagrams illustrating an example of screens displayed on the terminal device in the model update process and the text information generation process, respectively;

FIG. 10 is a sequence diagram illustrating an example of a measurement process in which a user requests the image management server to measure a distance between two points on an article or a property;

FIG. 11 is a diagram illustrating an example of a property designation screen;

FIG. 12 is a diagram illustrating an example of a speech text display screen;

FIG. 13 is a diagram illustrating an example of an image display screen;

FIG. 14 is a diagram illustrating an example of an image display screen;

FIG. 15 is a sequence diagram illustrating an example of a measurement process in which a user requests the image management server to measure a distance between two points on an article or a property;

FIG. 16 is a diagram illustrating an example of an image display screen including three-dimensional image information of a property;

FIG. 17 is a diagram illustrating an example of an image display screen on which measurement results are displayed;

FIG. 18 is a sequence diagram illustrating an example of the model update process;

FIG. 19 is a flowchart illustrating an example of a process in which a determination unit determines whether to update a first tacit knowledge model or a second tacit knowledge model;

FIG. 20 is a diagram illustrating an example of an image display screen including speech text and three-dimensional image information;

FIG. 21 is a sequence diagram illustrating an example of the text information generation process;

FIG. 22 is a diagram illustrating an example of an image display screen in an inference phase;

FIG. 23 is a diagram illustrating an example of an image display screen including text information;

FIG. 24 is a sequence diagram illustrating an example of the model update process;

FIG. 25 is a diagram illustrating an example of an image display screen;

FIG. 26 is a sequence diagram illustrating an example of the text information generation process;

FIG. 27 is a diagram illustrating an example of an image display screen in the inference phase;

FIG. 28 is a diagram illustrating an example of an image display screen including text information;

FIG. 29 is a sequence diagram illustrating an example of a process in which the image management server updates a model through communication with the conference management server;

FIG. 30 is a sequence diagram illustrating an example of a process in which the image management server executes a simulation;

FIG. 31 is a diagram illustrating an example of an image display screen;

FIG. 32 is a diagram illustrating an example of a simulation result screen;

FIG. 33 is a diagram illustrating a functional configuration of an example of functions of the image management server, the conference management server, and the terminal device in the information processing system;

FIG. 34 is a sequence diagram illustrating an example of a process of generating text information and image information; and

FIG. 35 is a diagram illustrating an example of generated image information displayed on an image display screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and an information processing method performed by the information processing system according to an embodiment of the present disclosure will be described hereinafter with reference to the drawings. Supplementary Information Related to Tacit Knowledge

In the fields of civil engineering and architecture, the implementation of building information modeling (BIM)/construction information modeling (CIM) has been promoted for, for example, coping with the demographic shift towards an older population and enhancing labor efficiency and productivity.

BIM is a solution that involves utilizing a database of buildings, in which attribute data such as cost, finishing details, and management information is added to a three-dimensional (3D) digital model of a building. This model is created on a computer and utilized throughout every stage of the architectural process, including design, construction, and maintenance. The three-dimensional digital model is referred to as a 3D model in the following description.

CIM is a solution that has been proposed for the field of civil engineering (covering general infrastructure such as roads, electricity, gas, and water supply) following BIM, which has been advancing in the field of architecture. Similar to BIM, CIM is an approach aimed at improving the efficiency and sophistication of a series of construction production systems by sharing information through a 3D model among the parties involved.

A challenge in promoting the implementation of BIM and CIM is how to utilize the constructed BIM and CIM.

Specifically, a 3D model restored by BIM and CIM can be utilized for design and construction purposes and other work such as maintenance and site inspection. That is, BIM and CIM may be used for purposes other than blueprints, such as making a record in the 3D model or sharing the record with another person.

Since work performed on the 3D model is recordable as a log, tacit knowledge extractable based on the work will be effectively used to transfer technology from experts to beginners. This is expected to contribute to front-loaded business operations, as well as personnel development and other activities.

Focusing on the transfer of tacit knowledge, a challenge is how to transfer tacit knowledge between different tasks or between users with different levels of skill, as described above, for two-dimensional (2D) datasets (such as spherical images or planar images) as well as for 3D models.

Specifically, tacit knowledge is qualitative and difficult to quantify. Even when a tacit knowledge model is generated from tacit knowledge, it is difficult to secure confidence from a user about the tacit knowledge model and to promote the use of the tacit knowledge model. For example, if the field of expertise of the user differs from the field of expertise of the tacit knowledge model, the tacit knowledge model has no practical value for the user, no matter how excellent the tacit knowledge model is. Similarly, if the knowledge level of the tacit knowledge model is lower than the knowledge level of the user, the tacit knowledge model also lacks value for the user.

However, it is a fact that the tacit knowledge model provides the user with a new point of view or awareness, and the use of the tacit knowledge model allows even an inexperienced user to acquire know-how or technology and use the know-how or technology for work.

In addition, it is desirable that a system including a terminal device and a first server that stores speech text obtained during a conference regarding a property further has a function of displaying at least one of three-dimensional image information such as a 3D model corresponding to the property and a capture-generated image that is captured during the conference.

To this end, it is possible that the first server acquires at least one of three-dimensional image information such as a 3D model corresponding to the property and a capture-generated image that is captured during the conference. However, this configuration involves additional functions of the first server, which results in an increase in cost.

Accordingly, in one or more embodiments of the present disclosure, processing based on speech text that is managed by a first server and at least one of three-dimensional image information and a capture-generated image that are managed by a second server is performed by the second server. This processing includes processing of displaying, on a single screen, the speech text managed by the first server and at least one of the three-dimensional image information and the capture-generated image managed by the second server.

Further, the second server can cause the terminal device to display two items of information and also display tacit knowledge related to a property, such as text information, which is generated based on at least one of the capture-generated image and the three-dimensional image information, in association with the three-dimensional image information or the capture-generated image. Accordingly, the terminal device can display the speech text and at least one of the three-dimensional image information and the capture-generated image on a single screen in association with each other or display the tacit knowledge related to the property in association with at least one of the three-dimensional image information and the capture-generated image without large addition of functions to the first server.

### Terminology

The term “user” refers to a person who uses text information generated by a tacit knowledge model. As the text information, content other than text, such as images, may be output. The term “data provider” refers to a person who provides data to be used by a tacit knowledge model for training, such as voice information, character information, operation information, images, and 3D data.

Tacit knowledge (or implicit knowledge) is knowledge that is based on personal experience, intuition, and the like. The term “tacit knowledge model” refers to a model that learns tacit knowledge and outputs an answer to a question based on the learned tacit knowledge. The term “model” refers to a mechanism or artificial intelligence (AI) that learns correspondences between input data and output data and outputs output data for input data. The output data may or may not be labeled data.

The term “property” refers to any space in which articles can be placed, such as a facility or a room in a facility. The term “article” refers to an object placed in a property. Articles to be placed vary depending on the functions of the facility.

Examples of properties include real estate, factories, construction sites, research facilities, medical facilities, agricultural land, warehouses, and equipment involving maintenance. Examples of articles include furniture, construction materials, equipment, heavy machinery, tools, instruments, materials, cultures, and foods.

The term “target object” refers to an object whose image is to be captured with an image capturing device. Specific examples of a target object include an object whose states can be managed by keeping records in the form of images. In embodiments disclosed herein, a target object is described using the term “article”. A target object is placed in a property, for example.

Three-dimensional image information of an article is an image obtained by capturing an image of a 3D model with a virtual camera. A user can change the point of view of the three-dimensional image information.

The term “generated information” refers to information generated based on three-dimensional image information and a capture-generated image. The generated information may be generated by a tacit knowledge model. In embodiments disclosed herein, generated information is described using the term “tacit knowledge comment” or “text information”.

The term “display screen” refers to a screen on which, for example, one or more of three-dimensional image information, a capture-generated image, and generated information are displayed at a time.

The term “wide-view image” refers to an image representing an imaging range including even an area that is difficult for a normal angle of view to cover. A wide-view image is an image having a wide viewing angle and captured in a wide imaging range. Such an image includes a 360-degree image that is a captured image of an entire 360-degree view. The 360-degree image is also referred to as a spherical image, an omnidirectional image, or an “all-around” image.

The term “predetermined-area image” refers to an image corresponding to a predetermined area that is a portion of a wide-view image. A predetermined-area image is projected onto a two-dimensional plane and is a planar image. In embodiments disclosed herein, a predetermined-area image is referred to as a capture-generated image since the predetermined-area image is stored by a capture operation.

The term “first processing” refers to the updating of the first tacit knowledge model or the generation of text information using speech text. The term “second processing” refers to the updating of the second tacit knowledge model or the generation of text information without using speech text (but using input information). The term “third processing” refers to a function unique to an image management server and refers to, for example, a simulation.

### First Embodiment

### Example of System Configuration

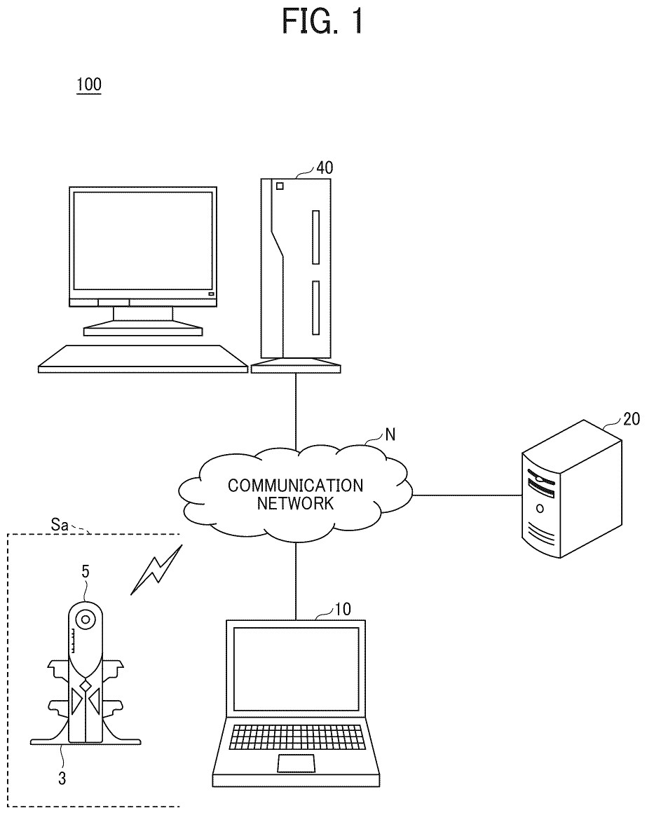

FIG. 1 is a diagram illustrating a general arrangement of an information processing system 100. The information processing system 100 includes a terminal device 10, which is an example of an input/output device, an image capturing device 5, an image management server 40, and a conference management server 20. The terminal device 10 may be external to the information processing system 100 as long as the terminal device 10 can be connected to the image management server 40 or the conference management server 20 as appropriate.

The image management server 40 (an example of a second server) includes one or more information processing apparatuses that can communicate with the terminal device 10 via a communication network N. The image management server 40 manages three-dimensional image information and capture-generated images of a property and includes a tacit knowledge model and a large language model. The image management server 40 uses the tacit knowledge model and the large language model to return text information including tacit knowledge to a user. The image management server 40 may be a web server that returns a processing result to the terminal device 10 in response to a request from the terminal device 10. The term “server” refers to a computer or software that implements a function for providing information or a processing result in response to a request from a client.

The image management server 40 may support cloud computing. Cloud computing is a mode of use that allows resources on a network to be used without identifying specific hardware resources. Cloud computing may be implemented in any form such as software as a service (SaaS), platform as a service (PaaS), or infrastructure as a service (IaaS). Accordingly, the image management server 40 may be housed in one or more housings or provided as one or more apparatuses. The functions of the image management server 40 may be distributed to a plurality of information processing apparatuses, or each of the plurality of information processing apparatuses may have all the functions of the image management server 40 and the information processing apparatus to be used for processing may be switched according to load balancing or the like.

Instead of including the tacit knowledge model and the large language model, the image management server 40 may call an application programming interface (API) published by an external system, and use at least one of the tacit knowledge model and the large language model.

The conference management server 20 (an example of a first server) includes one or more information processing apparatuses that can communicate with the terminal device 10 via the communication network N. The conference management server 20 manages speech text of utterances captured during a conference regarding the property. The conference management server 20 does not store three-dimensional image information or stores three-dimensional image information, if any, that is merely a photograph or the like different from an image managed by the image management server 40.

The conference management server 20 may be a web server that returns a processing result to the terminal device 10 in response to a request from the terminal device 10. The conference management server 20 can communicate with the image management server 40 via the communication network N. The conference management server 20 may support either cloud computing or on-premises.

The terminal device 10 is a general-purpose information processing terminal used by a user of the information processing system 100. In the terminal device 10, a web browser or a native application dedicated to the image management server 40 or the conference management server 20 operates. In a case where the terminal device 10 executes a web browser, the terminal device 10 and the image management server 40 or the conference management server 20 execute a web application. The web application is an application that operates in cooperation with a program written in a programming language (e.g., JavaScript®) operating on a web browser and a program on the web server (e.g., the image management server 40). In a case where the web application is executed, processing according to the present embodiment may be performed by the image management server 40 or the conference management server 20, or may be performed by the terminal device 10 that has received the web application.

An application that is installed and executed locally on the terminal device 10 is referred to as a native application. Also in the present embodiment, the application executed on the terminal device 10 may be either a web application or a native application. In a case where the native application is executed, the processing according to the present embodiment may be performed by the image management server 40 or the terminal device 10 that executes the native application.

In one example, the terminal device 10 is a personal computer (PC), a smartphone, a personal digital assistant (PDA), or a tablet terminal. The terminal device 10 is any device on which a web browser or a native application operates. The terminal device 10 may be an electronic whiteboard, a television receiver, a glasses device, or a wearable device. A plurality of terminal devices 10 may be present.

The terminal device 10 can communicate with the image management server 40 and the conference management server 20 via the communication network N. The communication network N is implemented by, for example, the Internet, a local area network (LAN), or a provider service. The communication network N may include a wired communication network and a wireless LAN-based network or a mobile communication network such as a third generation (3G), Worldwide Interoperability for Microwave Access (WiMAX), or Long Term Evolution (LTE) network. The terminal device 10 also supports communication using short-range communication technology such as Bluetooth® or near field communication (NFC®).

The image capturing device 5 is a digital camera for obtaining a wide-view image and recording audio. The image capturing device 5 is connected to the communication network N via a relay device 3. The relay device 3 has a function of a cradle for charging the image capturing device 5 and transmitting and receiving data to and from the image capturing device 5. The relay device 3 can perform data communication with the image capturing device 5 via a contact point and can also perform data communication with the conference management server 20 via the communication network N. The image capturing device 5 and the relay device 3 are placed at predetermined positions in a site Sa such as a construction site, an exhibition site, an education site, or a medical site. The image capturing device 5 may be a digital camera that obtains ordinary narrow field-of-view captured images, such as a single-lens reflex camera, and the conference management server 20 may distribute live images of narrow field-of-view captured images captured by the image capturing device 5. In a case where the image capturing device 5 obtains a narrow field-of-view captured image, the predetermined-area image is an image corresponding to a predetermined area that is all or a portion of the captured image.

In FIG. 1, the image management server 40, the conference management server 20, and the terminal device 10 communicate with one another via the communication network N. In another example, a user may directly operate the image management server 40 or the conference management server 20 from a console.

### Example of Hardware Configuration

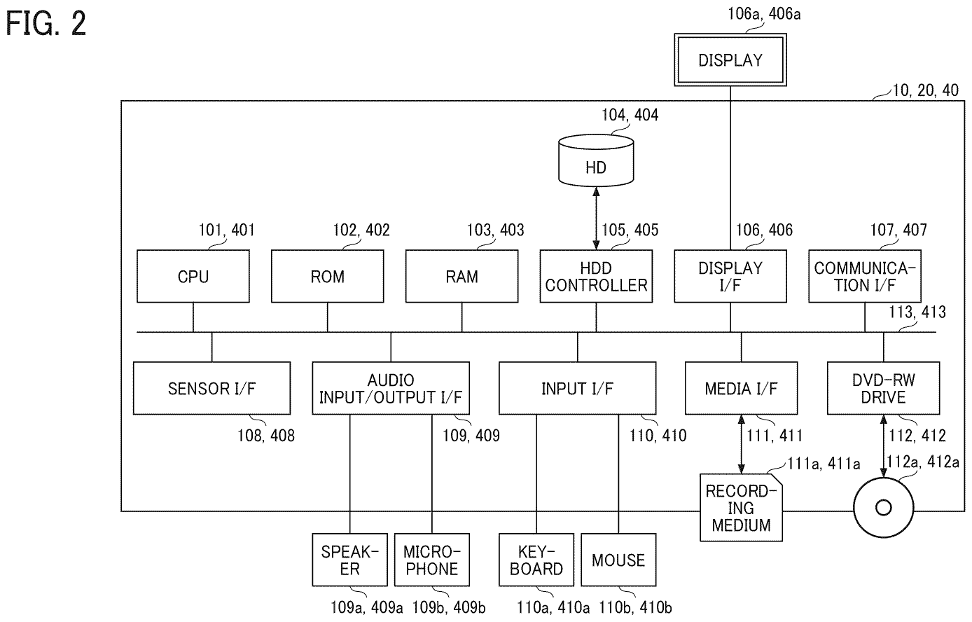

FIG. 2 is a diagram illustrating a hardware configuration of the image management server 40, the conference management server 20, and the terminal device 10. The hardware elements of the image management server 40 and the conference management server 20 are designated by reference numerals in the 400 series. The hardware elements of the terminal device 10 are designated by reference numerals in the 100 series.

The following describes the hardware elements of the terminal device 10. Since the hardware elements of the image management server 40 and the conference management server 20 are similar to those of the terminal device 10, the description thereof will be omitted.

The terminal device 10 is implemented by a computer. As illustrated in FIG. 2, the terminal device 10 includes a central processing unit (CPU) 101, a read-only memory (ROM) 102, a random-access memory (RAM) 103, a hard disk (HD) 104, a hard disk drive (HDD) controller 105, a display interface (I/F) 106, and a communication I/F 107.

The CPU 101 controls the overall operation of the terminal device 10. The ROM 102 stores a program used for booting the CPU 101, such as an initial program loader (IPL). The RAM 103 is used as a work area for the CPU 101.

The HD 104 stores various data such as a program. The HDD controller 105 controls reading or writing of various data from or to the HD 104 under the control of the CPU 101.

The display I/F 106 is a circuit that controls a display 106a to display an image. The display 106a is a type of display unit such as a liquid crystal display or an organic electroluminescent (EL) display that displays various types of information such as a cursor, a menu, a window, characters, or an image. The communication I/F 107 is an interface used for communication with another device.

When the terminal device 10 is a glasses device, the terminal device 10 may use a circuit that controls a member having transmissive and reflective properties, such as a lens, to display an image as an alternative to the display I/F 106.

The communication I/F 107 is, for example, a network interface card (NIC) in compliance with Transmission Control Protocol/Internet Protocol (TCP/IP).

The terminal device 10 further includes a sensor I/F 108, an audio input/output I/F 109, an input I/F 110, a media I/F 111, and a digital versatile disc rewritable (DVD-RW) drive 112.

The sensor I/F 108 is an interface that receives information detected by various sensors. The audio input/output I/F 109 is a circuit that processes the input of audio signals from a microphone 109b and the output of audio signals to a speaker 109a under the control of the CPU 101. The input I/F 110 is an interface for connecting predetermined input means to the terminal device 10.

A keyboard 110a is a type of input means including multiple keys for inputting, for example, characters, numerical values, or various instructions. A mouse 110b is a type of input means for selecting or executing various instructions, selecting a target for processing, moving a cursor being displayed, or performing an operation on a display screen.

The media I/F 111 controls reading or writing (storing) data from or to a recording medium 111a such as flash memory. The DVD-RW drive 112 controls reading or writing of various data from or to a DVD-RW 112a, which is an example of a removable recording medium. In place of the DVD-RW 112a, a digital versatile disc recordable (DVD-R) may be used. In place of the DVD-RW drive 112, a Blu-ray drive that controls reading or writing of various data from or to a Blu-ray Disc® may be used.

The terminal device 10 further includes a bus line 113. Examples of the bus line 113 include an address bus and a data bus. The bus line 113 electrically connects the components of the terminal device 10, such as the CPU 101, to one another.

The programs described above may be stored in recording media such as an HD and a compact disc read-only memory (CD-ROM), and the recording media may be distributed domestically or internationally as program products. For example, the terminal device 10 executes a program according to an embodiment of the present disclosure to implement an information processing method according to an embodiment of the present disclosure.

### Functions

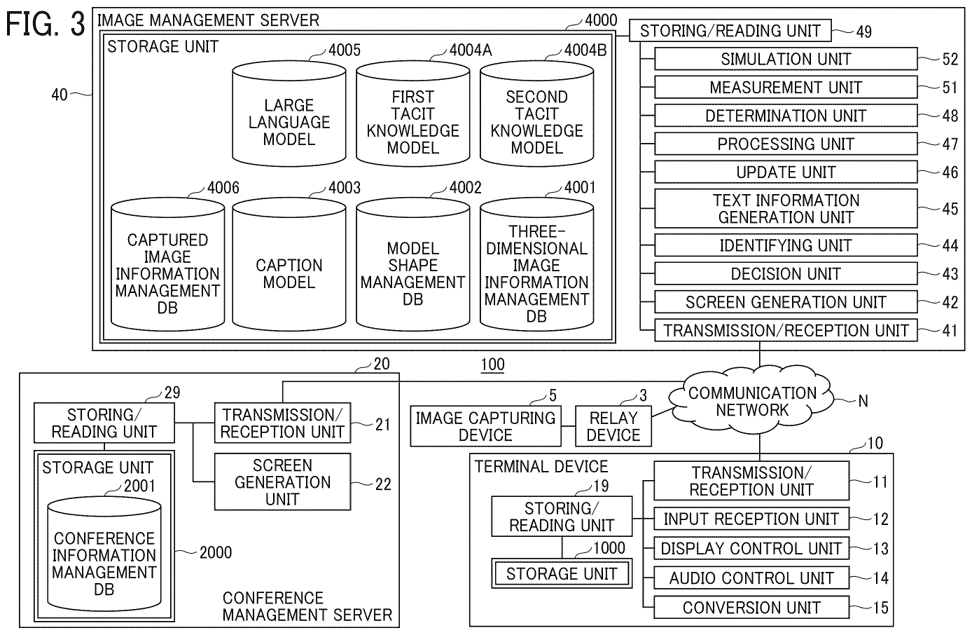

FIG. 3 is a diagram illustrating a functional configuration of functions of the image management server 40, the conference management server 20, and the terminal device 10 in the information processing system 100. The image capturing device 5 and the relay device 3 have existing functions.

### Terminal Device

As illustrated in FIG. 3, the terminal device 10 includes a transmission/reception unit 11, an input reception unit 12, a display control unit 13, an audio control unit 14, a conversion unit 15, and a storing/reading unit 19. Each of these units is a function implemented by or means caused to function by any one or more of the hardware elements illustrated in FIG. 2 operating in accordance with instructions from the CPU 101 according to a program loaded onto the RAM 103 from the HD 104. The terminal device 10 further includes a storage unit 1000, which is implemented by at least one of the RAM 103 and the HD 104 illustrated in FIG. 2.

The transmission/reception unit 11 is an example of transmission means and is implemented by instructions from the CPU 101 illustrated in FIG. 2 and by the communication I/F 107 illustrated in FIG. 2. The transmission/reception unit 11 transmits and receives various data (or information) to and from another terminal, device, apparatus, or system via the communication network N.

The input reception unit 12 is an example of input reception means and is implemented by instructions from the CPU 101 illustrated in FIG. 2 and by the input I/F 110 and the audio input/output I/F 109 illustrated in FIG. 2. The input reception unit 12 receives various inputs from a user through the microphone 109b, the keyboard 110a, and the mouse 110b.

The display control unit 13 is an example of display control means and output means and is implemented by instructions from the CPU 101 illustrated in FIG. 2 and by the display I/F 106 illustrated in FIG. 2. The display control unit 13 controls the display 106a, which is an example of a display unit, to display various images and screens. When the terminal device 10 is a glasses device, the display control unit 13 controls a member having transmissive and reflective properties, such as a lens, to display a virtual image as an alternative to the display I/F 106.

The audio control unit 14 is an example of audio control means and output means and is implemented by instructions from the CPU 101 illustrated in FIG. 2 and by the audio input/output I/F 109 illustrated in FIG. 2. The audio control unit 14 controls the speaker 109a, which is an example of an audio reproduction unit, to reproduce audio.

The conversion unit 15 is an example of processing means and is implemented by instructions from the CPU 101 illustrated in FIG. 2. The conversion unit 15 performs processing for converting character information into voice information or processing for converting voice information into character information.

The storing/reading unit 19 is an example of storage control means and is implemented by instructions from the CPU 101 illustrated in FIG. 2 and by the HD 104, the media I/F 111, and the DVD-RW drive 112 illustrated in FIG. 2. The storing/reading unit 19 stores various data in the storage unit 1000, the recording medium 111a, or the DVD-RW 112a and reads various data from the storage unit 1000, the recording medium 111a, or the DVD-RW 112a.

### Functional Configuration of Image Management Server

The image management server 40 includes a transmission/reception unit 41, a screen generation unit 42, a decision unit 43, an identifying unit 44, a text information generation unit 45, an update unit 46, a processing unit 47, a determination unit 48, a measurement unit 51, a simulation unit 52, and a storing/reading unit 49. Each of these units is a function implemented by or means caused to function by any one or more of the hardware elements illustrated in FIG. 2 operating in accordance with instructions from the CPU 401 according to a program loaded onto the RAM 403 from the HD 404. The image management server 40 further includes a storage unit 4000, which is implemented by the HD 404 illustrated in FIG. 2. The storage unit 4000 is an example of storage means.

In FIG. 3, the single image management server 40 has all the functions described above. The image management server 40 may be configured to implement the functions in a distributed manner across multiple computers.

The transmission/reception unit 41 is an example of a transmission unit or a reception unit and is implemented by instructions from the CPU 401 illustrated in FIG. 2 and by the communication I/F 407 illustrated in FIG. 2. The transmission/reception unit 41 transmits and receives various data (or information) to and from another terminal, device, apparatus, or system via the communication network N.

The screen generation unit 42 is an example of screen generation means and is implemented by instructions from the CPU 401 illustrated in FIG. 2. The screen generation unit 42 generates various screens. In a case where the terminal device 10 executes a web application, screen information is created by Hypertext Markup Language (HTML), Extensible Markup Language (XML), Cascading Style Sheets (CSS), JavaScript®, or the like. Thus, the screen information may be referred to as a web application. In a case where the terminal device 10 executes a client application, the screen information is stored in the terminal device 10, and the information to be displayed is transmitted in the form of, for example, XML.

The decision unit 43 is an example of determination means and is implemented by instructions from the CPU 401 illustrated in FIG. 2. The decision unit 43 performs various determinations described below.

The identifying unit 44 is an example of identifying means and is implemented by instructions from the CPU 401 illustrated in FIG. 2. The identifying unit 44 identifies a target image.

The text information generation unit 45 is an example of text information generation means and is implemented by instructions from the CPU 401 illustrated in FIG. 2. The text information generation unit 45 acquires a tacit knowledge comment, based on a first tacit knowledge model 4004A or a second tacit knowledge model 4004B described below, or generates text information, based on a large language model 4005.

The update unit 46 is an example of update means and is implemented by instructions from the CPU 401 illustrated in FIG. 2. The update unit 46 updates the first tacit knowledge model 4004A or the second tacit knowledge model 4004B.

The processing unit 47 is implemented by instructions from the CPU 401 illustrated in FIG. 2, and performs processing for associating three-dimensional image information with speech text in accordance with processing requested by the user. The processing unit 47 performs processing for associating generated information, which is based on three-dimensional image information and speech text, with the three-dimensional image information in accordance with processing requested by the user. Examples of such association processing include processing for displaying the generated information and the three-dimensional image information on a single screen, processing for updating the first tacit knowledge model 4004A or the second tacit knowledge model 4004B, and processing for generating text information based on the first tacit knowledge model 4004A or the second tacit knowledge model 4004B. The processing unit 47 requests, for example, the screen generation unit 42 or the text information generation unit 45 to perform processing in accordance with the content of the processing.

The determination unit 48 is implemented by instructions from the CPU 401 illustrated in FIG. 2, and determines which of the first tacit knowledge model 4004A (an example of a first model) and the second tacit knowledge model 4004B (an example of a second model) is to be used. In a case where the user has logged in to the image management server 40 via the conference management server 20, the determination unit 48 determines to use the first tacit knowledge model 4004A. In a case where the user has logged in directly to the image management server 40, the determination unit 48 determines to use the second tacit knowledge model 4004B.

The measurement unit 51 is implemented by instructions from the CPU 401 illustrated in FIG. 2, and measures a distance between two points designated by the user.

The simulation unit 52 is implemented by instructions from the CPU 401 illustrated in FIG. 2, and performs a preset simulation on a property or an article. The simulation includes various types of processes such as the prediction of an airflow in the property, prediction based on the size of an article in the property (e.g., whether the article can be carried in or installed), the counting of the number of articles, and the calculation of the volume of a space.

The storing/reading unit 49 is an example of storage control means and is implemented by instructions from the CPU 401 illustrated in FIG. 2 and by the HD 404, the media I/F 411, and the DVD-RW drive 412 illustrated in FIG. 2. The storing/reading unit 49 stores various data in the storage unit 4000, the recording medium 411a, or the DVD-RW 412a and reads various data from the storage unit 4000, the recording medium 411a, or the DVD-RW 412a. The storage unit 4000, the recording medium 411a, and the DVD-RW 412a are examples of storage means.

The storage unit 4000 includes a three-dimensional image information management DB 4001, a model shape management DB 4002, a caption model 4003, the first tacit knowledge model 4004A, the second tacit knowledge model 4004B, the large language model 4005, and a captured image information management DB 4006.

The three-dimensional image information management DB 4001 manages three-dimensional image information of articles placed in a property. The three-dimensional image information is information on visual representations of articles (also referred to as models) placed in the property. The model shape management DB 4002 manages three-dimensional model shape information of the articles placed in the property. The image management server 40 can generate three-dimensional image information related to the property, based on the three-dimensional model shape information. The three-dimensional model shape information is information for drawing the articles in three dimensions, such as three-dimensional point clouds or three-dimensional models of the articles. The three-dimensional model shape information may include, for example, polygons or computer-aided design (CAD) models. The three-dimensional image information management DB 4001 or the model shape management DB 4002 preferably stores a wide-view image such as a spherical image of the property.

The caption model 4003 is generated by performing a learning process using combinations of images and caption comments as training data, and causes a computer to function to output a caption comment based on an image. The caption comment is explicit knowledge and is used as a term corresponding to implicit knowledge or tacit knowledge. The caption comment is text data and is a comment describing an image among, for example, comments expressed by voice or characters. A caption comment related to a property or an article is associated with identification information of the property or the article.

The first tacit knowledge model 4004A is generated by performing a learning process using, as training data, correspondences among three-dimensional image information, capture-generated images, and tacit knowledge (such as input information and speech text) with respect to the three-dimensional image information and the capture-generated images, and causes a computer to function to output a tacit knowledge comment based on an image. The first tacit knowledge model 4004A learns by associating information as follows: correspondences among three-dimensional image information, capture-generated images, and input information, correspondences among three-dimensional image information, capture-generated images, and speech text, and correspondences among three-dimensional image information, capture-generated images, speech text, and input information. The tacit knowledge comment is text data and is a comment excluding a caption comment, that is, a comment regarding content not represented in an image, among the comments expressed by voice or characters.

The second tacit knowledge model 4004B does not use a capture-generated image or speech text for learning. That is, the second tacit knowledge model 4004B is generated by performing a learning process using correspondences between three-dimensional image information of articles and input information as training data, and causes a computer to function to output a tacit knowledge comment based on the three-dimensional image information.

The large language model 4005 is a computer language model generated by performing a learning process using a vast amount of unlabeled text as training data. The large language model 4005 includes an artificial neural network having a large number of parameters. The large language model 4005 is sufficiently trained by a method for learning context, such as next sentence prediction or a masked language model, to capture much of the syntax and meaning of human language. The next sentence prediction understands context by determining whether sentence 1 and sentence 2 are consecutive. The masked language model understands context by masking a word in a sentence and predicting the masked word from the words before and after the masked word.

The captured image information management DB 4006 stores wide-view images in time series for management. The wide-view images are captured by the image capturing device 5 during, for example, a conference regarding the property. The wide-view images may be moving images. When a user of a communication terminal described below performs a capture operation, capture-generated images are stored. The term “capture” refers to storing, as a still image, a predetermined area indicating a predetermined-area image in a wide-view image. The captured image information management DB 4006 also stores speech text acquired from the conference management server 20 in association with timestamps of image capture for management. The speech text is text data converted from audio data recorded by the image capturing device 5 or the communication terminal during, for example, the conference.

### Three-Dimensional Image Information Management Table

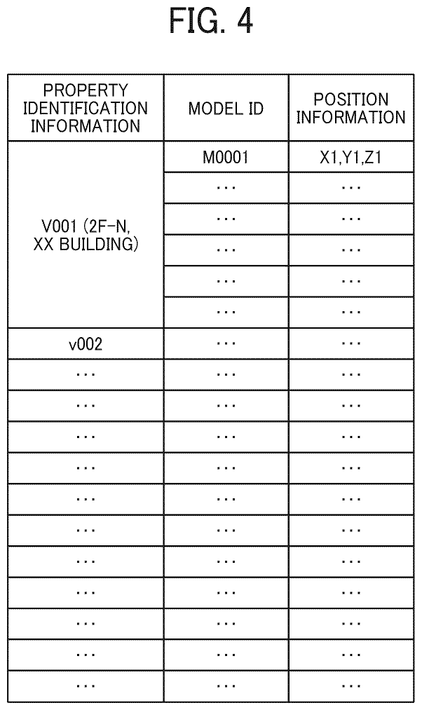

FIG. 4 is an illustration of an example of a three-dimensional image information management table according to the present embodiment. In the storage unit 4000, the three-dimensional image information management DB 4001 stores the three-dimensional image information management table as illustrated in FIG. 4. In the three-dimensional image information management table illustrated in FIG. 4, a model ID and position information are related to one another and managed in association with property identification information.

The property identification information is an example of property identification information for identifying a property. The term “property” refers to any space in which articles can be placed, such as a facility or a room in a facility. Articles to be placed vary depending on the functions of the facility. The property may be any property represented in a unit easy to manage, such as “2F-N, XX Building (meaning the north side of the second floor of XX Building)”.

The model ID is an example of an ID of a model for identifying an article placed in the property. The articles may be represented by three-dimensional model shape information such as polygons or CAD models in the model shape management DB 4002. With a model ID, three-dimensional image information is related to a three-dimensional model shape in the model shape management DB 4002.

The position information is information indicating the position of a model of an article in a three-dimensional virtual space using three-dimensional XYZ coordinates. The three-dimensional virtual space represents the property in a virtual space. The position information is indicated by, for example, three-dimensional coordinates of eight points defining a rectangular parallelepiped space occupied by a model.

This position information is measured as position information (latitude, longitude, and altitude) of the relay device 3 by a Global Navigation Satellite System (GNSS) satellite such as a Global Positioning System (GPS) satellite or by an indoor messaging system (IMES) serving as an indoor GPS. Technologies for indoor positioning include Wireless Fidelity (Wi-Fi) positioning, Radio Frequency Identifier (RFID) positioning, beacon positioning, pedestrian dead reckoning positioning, geomagnetism positioning, acoustic positioning, and ultra-wideband (UWB) positioning.

As described above, the position information illustrated in FIG. 4 is managed in association with the absolute position on the earth. In one example, by associating the origin (X=0, Y=0, Z=0) of the position information illustrated in FIG. 4 with the absolute position (latitude, longitude, and altitude) on the earth, all coordinates in the three-dimensional image, including the three-dimensional models or articles, are associated with the absolute positions on the earth. That is, three-dimensional image information and a capture-generated image are aligned in position with each other.

In addition to the position information, an instruction manual, a daily report, a quotation, drawings, and the like may be registered in the three-dimensional image information management table.

### Captured Image Information Management Table

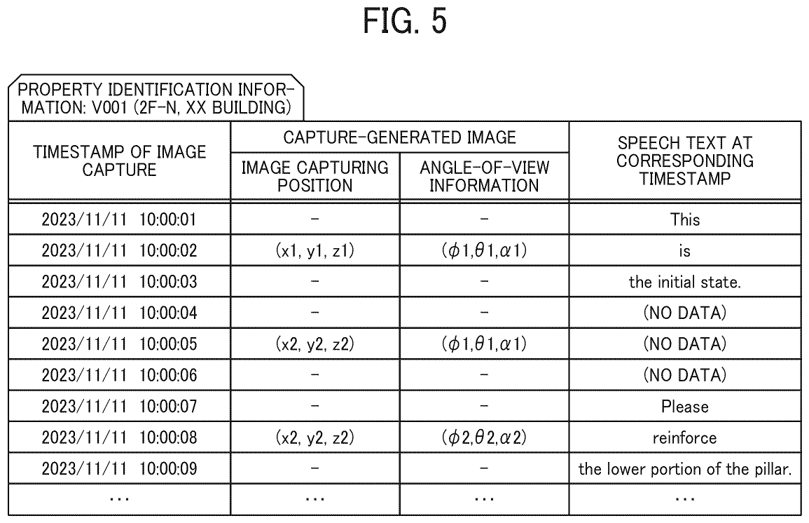

FIG. 5 is an illustration of an example of a captured image information management table according to the present embodiment. In the storage unit 4000, the captured image information management DB 4006 stores the captured image information management table as illustrated in FIG. 5. In the captured image information management table illustrated in FIG. 5, a timestamp of image capture, a wide-view image, a capture-generated image, an image capturing position, angle-of-view information, and speech text at the corresponding timestamp are related to each other and stored for management in association with property identification information. The position of the image capturing device 5 is measured by, for example, the GNSS of the relay device 3 to which the image capturing device 5 is attached. The timestamp of image capture indicates information on the date and time at which the capture-generated image is captured by the image capturing device 5. One or more capture-generated images are stored in association with a timestamp of image capture. The image capturing position indicates the position (absolute position on the earth) of the image capturing device 5 when a capture-generated image is captured. The capture-generated image is stored directly in the image management server 40. The angle-of-view information is information for specifying, on a wide-view image, a predetermined area indicating a predetermined-area image displayed on a communication terminal. As described below, the communication terminal is a terminal for viewing a real-time wide-view image in a conference. Speech text registered in the “speech text at the corresponding timestamp” column is speech text generated through speech recognition of audio captured by the image capturing device 5. The speech text at the corresponding timestamp is speech text transmitted from the conference management server 20.

### Functional Configuration of Conference Management Server

Reference is made back to FIG. 3. The conference management server 20 includes a transmission/reception unit 21, a screen generation unit 22, and a storing/reading unit 29. Each of these units is a function implemented by or means caused to function by any one or more of the hardware elements illustrated in FIG. 2 operating in accordance with instructions from the CPU 401 according to a program loaded onto the RAM 403 from the HD 404. The conference management server 20 further includes a storage unit 2000, which is implemented by the HD 404 illustrated in FIG. 2. The storage unit 2000 is an example of storage means.

In FIG. 3, the single conference management server 20 has all the functions described above. The conference management server 20 may be configured to implement the functions in a distributed manner across multiple computers.

The transmission/reception unit 21 is an example of a transmission unit or a reception unit and is implemented by instructions from the CPU 401 illustrated in FIG. 2 and by the communication I/F 407 illustrated in FIG. 2. The transmission/reception unit 21 transmits and receives various data (or information) to and from another terminal, device, apparatus, or system via the communication network N.

The screen generation unit 22 is an example of screen generation means and is implemented by instructions from the CPU 401 illustrated in FIG. 2. The screen generation unit 22 generates various screens. In a case where the terminal device 10 executes a web application, screen information is created by HTML, XML, CSS, JavaScript®, or the like. Thus, the screen information may be referred to as a web application. In a case where the terminal device 10 executes a client application, the screen information is stored in the terminal device 10, and the information to be displayed is transmitted in the form of, for example, XML.

The storing/reading unit 29 is an example of storage control means and is implemented by instructions from the CPU 401 illustrated in FIG. 2 and by the HD 404, the media I/F 411, and the DVD-RW drive 412 illustrated in FIG. 2. The storing/reading unit 29 stores various data in the storage unit 2000, the recording medium 411a, or the DVD-RW 412a and reads various data from the storage unit 2000, the recording medium 411a, or the DVD-RW 412a. The storage unit 2000, the recording medium 411a, and the DVD-RW 412a are examples of storage means.

### Conference Information Management Table

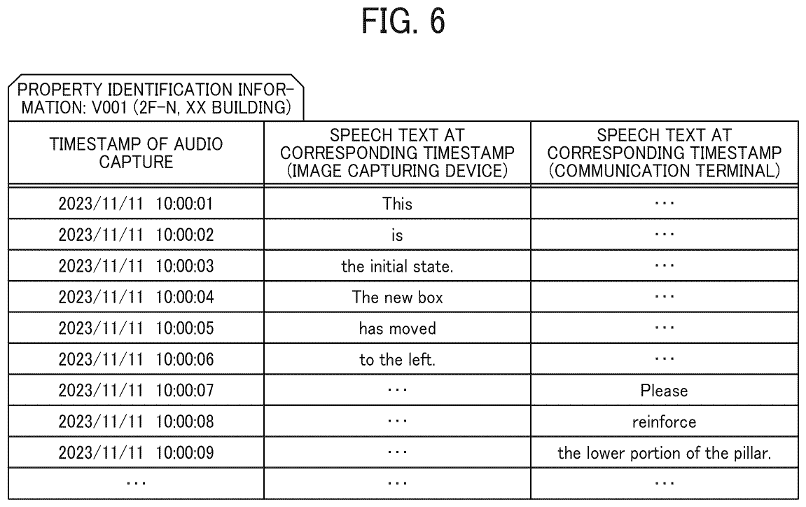

FIG. 6 is an illustration of an example of a conference information management table according to the present embodiment. The storage unit 2000 includes a conference information management DB 2001 storing the conference information management table as illustrated in FIG. 6.

In the conference information management table, a timestamp of audio capture, speech text at the corresponding timestamp (image capturing device), and speech text at the corresponding timestamp (communication terminal) are related to one another and stored for management in association with property identification information. The timestamp of audio capture indicates information on the date and time at which audio is captured by the image capturing device 5 or the communication terminal. Speech text registered in the “speech text at the corresponding timestamp (image capturing device)” column is speech text generated based on audio captured by the image capturing device 5. The speech text is comment data related to an article about which a participant in the conference has made an utterance while viewing the live images. Speech text registered in the “speech text at the corresponding timestamp (communication terminal)” column is speech text generated based on an utterance made by a user who is viewing live images on the communication terminal. The speech text is comment data related to an article about which a participant in the conference has made an utterance while viewing the live images.

### Transmission of Wide-View Image and Audio Data

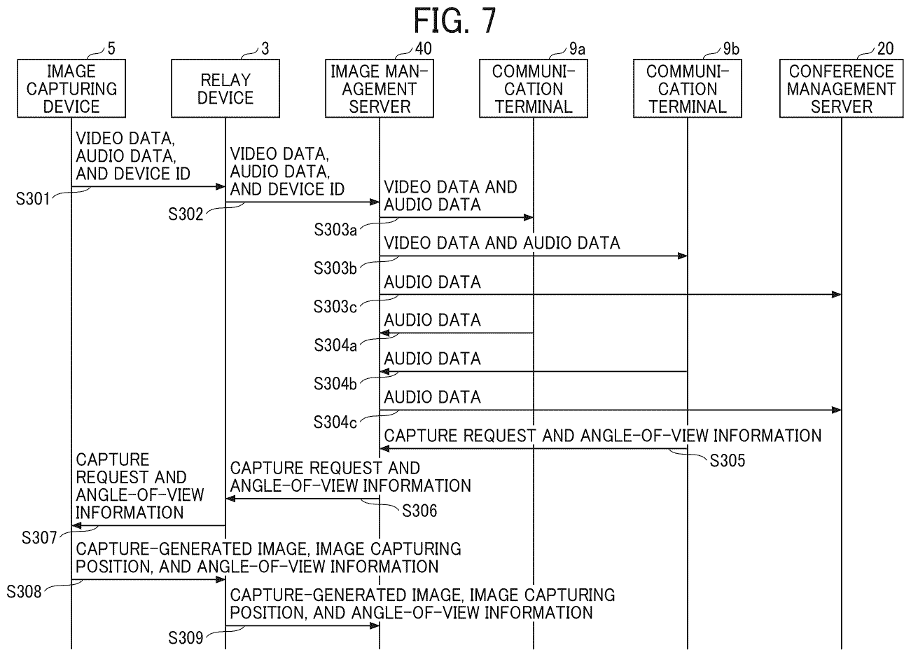

FIG. 7 is a sequence diagram illustrating a process of communicating a wide-view image and audio data. In the present embodiment, the image capturing device 5, a communication terminal 9a of a participant A, and a communication terminal 9b of a participant B participate in the same remote communication. The processing of S301 to S304c in FIG. 7 is repeatedly performed.

S301: The image capturing device 5 captures an image of surroundings and captures audio to obtain video data (wide-view image) and audio data, and transmits the video data and the audio data to the relay device 3. The image capturing device 5 also transmits a device ID for identifying the image capturing device 5 in order to identify a property. Accordingly, the relay device 3 acquires the video data and the audio data. In the image management server 40, the device ID and the property are associated with each other in advance.

S302: The relay device 3 transmits the video data, the audio data, and the device ID, which have been acquired, to the image management server 40 via the communication network N. In the image management server 40, accordingly, the transmission/reception unit 41 receives the video data, the audio data, and the device ID. The image management server 40 identifies the property by the device ID. As a result, wide-view images and timestamps of image capture are stored in the captured image information management DB 4006, for example, every second by the storing/reading unit 49. The wide-view images may be distributed as live images without being stored.

S303a: The image management server 40 reads participant IDs of participants in the same conference as the image capturing device 5 from, for example, conference information. The image management server 40 also reads IP addresses of the communication terminals 9a and 9b, based on the read participant IDs. The image management server 40 refers to the IP address of the communication terminal 9a and transmits the received video data and audio data to the communication terminal 9a. Accordingly, the communication terminal 9a receives the video data and the audio data and displays a wide-view image while outputting audio.

S303b: Likewise, the image management server 40 refers to the IP address of the communication terminal 9b and transmits the video data and the audio data to the communication terminal 9b. Accordingly, the communication terminal 9b displays a wide-view image while outputting audio.

S303c: The image management server 40 calls the API of the conference management server 20 to transmit the audio data to the conference management server 20. Thus, the transmission/reception unit 21 of the conference management server 20 receives the audio data. The conference management server 20 (or an existing speech recognition server) uses the audio data to convert an audio portion into text and generates text data (hereinafter referred to as speech text). The storing/reading unit 29 stores the speech text at the corresponding timestamp (image capturing device) in the conference information management DB 2001.

S304a and S304b: The communication terminals 9a and 9b transmit audio data of the participant A and audio data of the participant B to the conference management server 20, respectively. The audio data of the participant A and the audio data of the participant B are converted from utterances made by the participants A and B operating the communication terminals 9a and 9b, respectively, and acquired by respective microphones.

S304c: The image management server 40 calls the API of the conference management server 20 to transmit the audio data to the conference management server 20. Thus, the transmission/reception unit 21 of the conference management server 20 receives the audio data. The conference management server 20 (or an existing speech recognition server) uses the audio data to convert an audio portion into text and generates text data. The storing/reading unit 29 stores the speech text at the corresponding timestamp (communication terminal) in the conference information management DB 2001.

S305: The participant A of the communication terminal 9a and the participant B of the communication terminal 9b (in FIG. 7, the participant B of the communication terminal 9b) can change the point of view of the video data, which is the wide-view image. The participant B can perform a capture operation at any time when the participant B desires to store a predetermined-area image that is a portion of a wide-view image displayed with a changed point of view. In response to acceptance of the capture operation, the communication terminal 9b transmits a capture request and angle-of-view information indicating the predetermined area currently displayed on a display of the communication terminal 9b to the image management server 40.

S306: In response to receiving the capture request and the angle-of-view information, the image management server 40 identifies the IP address of the relay device 3 participating in the same conference as the communication terminal 9b and transmits the capture request and the angle-of-view information to the relay device 3.

S307: The relay device 3 receives the capture request and the angle-of-view information and transfers the capture request and the angle-of-view information to the image capturing device 5.

S308: In response to receiving the capture request, the image capturing device 5 generates a capture-generated image based on the angle-of-view information. The image capturing device 5 transmits the capture-generated image, the image capturing position, and the angle-of-view information to the relay device 3. When the image capturing device 5 is in a fixed location, the image capturing position of the image capturing device 5 may be registered in the image management server 40 in advance.

S309: The relay device 3 transmits the capture-generated image, the image capturing position, and the angle-of-view information to the image management server 40. The image management server 40 identifies the property by the device ID in a manner similar to that in step S302. The storing/reading unit 49 stores the capture-generated image, the image capturing position, and the angle-of-view information in the captured image information management DB 4006.

As a result of the process described above, a capture-generated image captured from a wide-view image, an image capturing position, and angle-of-view information are stored in the captured image information management DB 4006. The conference information management DB 2001 stores the speech text transmitted from the image capturing device 5, the speech text transmitted from the communication terminal 9a, and the speech text transmitted from the communication terminal 9b. As described below, speech text stored in the conference information management DB 2001 may be transmitted to the captured image information management DB 4006.

### Example of Model Update and Text Information Generation

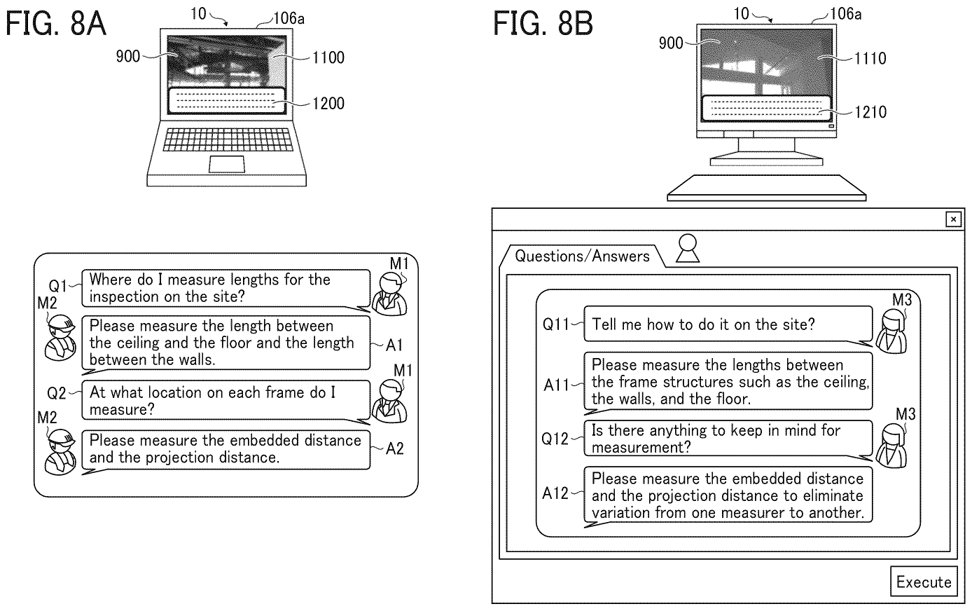

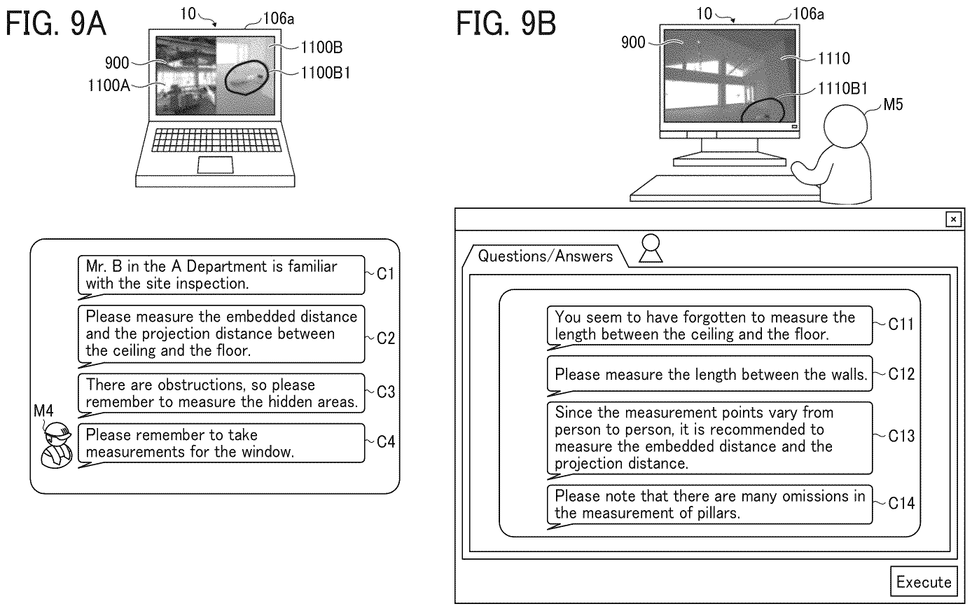

A model update method and a text information generation method will be described with reference to FIGS. 8A, 8B, 9A, and 9B. While speech text is not used for model update and text information generation in FIGS. 8A, 8B, 9A, and 9B, utterances described below, such as an utterance Q1, may be replaced with speech text or speech text may be added to the utterances described below to perform learning in a similar manner.

FIGS. 8A and 8B are diagrams illustrating screens displayed on the terminal device 10 in a model update process and a text information generation process, respectively. FIG. 8A illustrates the model update process. The display control unit 13 of the terminal device 10 controls the display 106a to display a display screen 900 received from the image management server 40. The display screen 900 includes a target image 1100 and text 1200.

The input reception unit 12 of the terminal device 10 receives voice information from the microphone 109b as input information input by data providers on the displayed display screen 900. The voice information indicates utterances Q1, A1, Q2, and A2 made by data providers M1 and M2. The data providers M1 and M2 preferably have a wealth of knowledge including tacit knowledge regarding the business. A tacit knowledge model is updated based on such interactions between the data providers M1 and M2, thus allowing a user to obtain useful tacit knowledge comments.

The identifying unit 44 identifies the target image 1100, which is a portion excluding the text 1200 from the display screen 900.

Then, the decision unit 43 determines the levels of relevance between a caption comment acquired from the caption model 4003 using the target image 1100 and the utterances Q1, A1, Q2, and A2.

The update unit 46 updates the tacit knowledge model using the target image 1100 or the like and, as training data, a tacit knowledge comment that is a comment determined to have a low level of relevance among the utterances Q1, A1, Q2, and A2, and updates the caption model 4003 using the target image 1100 and, as training data, a caption comment that is a comment determined to have a high level of relevance among the utterances Q1, A1, Q2, and A2.

Thus, the tacit knowledge model is trained on the correspondences between the target image 1100 and the utterances Q1, A1, Q2, and A2. Features of the target image 1100 are extracted using some feature extraction models suitable for images, such as convolutional neural network (CNN) models. The features represent, for example, objects that appear in an image and positions of the objects appearing in the image, or operations that are being performed in the image. Thus, the tacit knowledge model can learn the correspondences between the features of the image and the utterances Q1, A1, Q2, and A2.

FIG. 8B illustrates the text information generation process. The display control unit 13 of the terminal device 10 controls the display 106a to display a display screen 900 received from the image management server 40. The display screen 900 includes an image 1110 and text 1210.

The input reception unit 12 of the terminal device 10 receives voice information via the microphone 109b as input information input by a user on the displayed display screen 900. The voice information indicates questions Q11 and Q12 uttered by a user M3.

The identifying unit 44 identifies the image 1110, which does not include the text 1210, as a target image.

The text information generation unit 45 uses the image 1110 to acquire a tacit knowledge comment, based on the tacit knowledge model. The tacit knowledge model extracts features from the image 1110, determines that the features of the image 1110 illustrated in FIG. 8B are similar to those of the image 1110 at the time of update, and can identify the utterances Q1, A1, Q2, and A2 related to the image 1110. The utterances Q1, A1, Q2, and A2 are set as tacit knowledge comments.

Further, the text information generation unit 45 uses, for example, the tacit knowledge comments (i.e., the utterances Q1, A1, Q2, and A2) and the questions Q11 and Q12 to generate text information regarding answers A11 and A12 to the questions Q11 and Q12, respectively, based on the large language model 4005.

The display control unit 13 of the terminal device 10 controls the display 106a to display text information regarding the answers A11 and A12 received from the image management server 40.

FIGS. 9A and 9B are diagrams illustrating other screens displayed on the terminal device 10 in the model update process and the text information generation process, respectively, according to the present embodiment. FIGS. 9A and 9B illustrate a case in which no question sentence is used for model update and text information generation.

FIG. 9A illustrates the model update process. In an example illustrated in FIG. 9A, the tacit knowledge model is updated using voice information of one data provider and a partial image, rather than a conversation between data providers.

The display control unit 13 of the terminal device 10 controls the display 106a to display a display screen 900 received from the image management server 40. The display screen 900 includes a first image 1100A and a second image 1100B.

The input reception unit 12 of the terminal device 10 receives character information from the keyboard 110a as input information input by a data provider on the displayed display screen 900. The character information indicates comments C1 to C4 made by a data provider M4.

The input reception unit 12 also receives operation information from the mouse 110b as input information input by the data provider M4 on the displayed display screen 900. The operation information indicates an operation performed by the data provider M4 to identify a partial image 1100B1 in the second image 1100B.

The identifying unit 44 may identify the partial image 1100B1 as the target image, or may identify the first image 1100A or the second image 1100B as the target image.

Then, the decision unit 43 determines the levels of relevance between the caption comment acquired from the caption model 4003 using the target image and the comments C1 to C4.

The update unit 46 updates the tacit knowledge model using the partial image 1100B1 or the like and, as training data, a tacit knowledge comment that is a comment determined to have a low level of relevance among the comments C1 to C4, and updates the caption model 4003 using the partial image 1100B1 and, as training data, a caption comment that is a comment determined to have a high level of relevance among the comments C1 to C4.

Thus, the tacit knowledge model is trained on the correspondences between the partial image 1100B1 and the comments C1 to C4. Features of the partial image 1100B1 are extracted using some feature extraction models suitable for images, such as CNN models. The features represent, for example, objects that appear in an image and positions of the objects appearing in the image, or operations that are being performed in the image. Thus, the tacit knowledge model can learn the correspondences between the features of the image and the comments C1 to C4.

FIG. 9B illustrates the text information generation process. The display control unit 13 of the terminal device 10 controls the display 106a to display a display screen 900 received from the image management server 40. The display screen 900 includes an image 1110.

A user M5 does not perform an input on the displayed display screen 900, and the input reception unit 12 does not receive input information input by a user on the displayed display screen 900. The identifying unit 44 identifies the image 1110, which is the entire display screen 900, as the target image.

When the user M5 performs an operation to identify the partial image 1100B1 on the display screen 900, the input reception unit 12 receives, as input information, operation information indicating the operation of identifying the partial image 1100B1, from the mouse 110b. In this case, the identifying unit 44 identifies the partial image 1100B1 on the display screen 900 as the target image in accordance with the operation information.

The text information generation unit 45 uses the partial image 1100B1 to acquire a tacit knowledge comment, based on the tacit knowledge model. The tacit knowledge model determines that the features of an image 1110B1 illustrated in FIG. 9B are similar to the features of the image 1110B1 at the time of update, and can identify the comments C1 to C4 related to the image 1110B1. The tacit knowledge model extracts the comments C1 to C4 as tacit knowledge comments. The text information generation unit 45 uses, for example, the tacit knowledge comments to generate text information regarding comments C11 to C14, based on the large language model 4005. The text information generation unit 45 may generate the text information using a preset standard question when no question sentence is input, rather than using a method that does not use any questions at all.

The display control unit 13 of the terminal device 10 controls the display 106a to display the text information regarding the comments C11 to C14 received from the image management server 40.

### Operations or Processes

### Login to Image Management Server via Conference Management Server

First, a case in which a user measures a distance between two points with respect to three-dimensional image information of a property will be described. The user may log in to the image management server 40 via the conference management server 20 or may log in directly to the image management server 40. The measurement results are the same regardless of the way in which the user logs in.

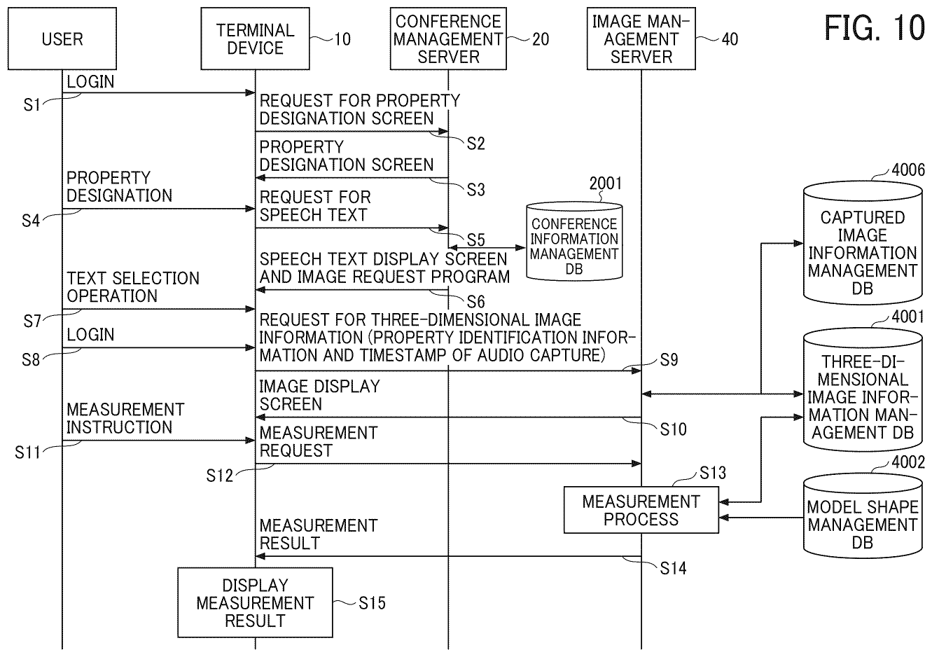

A case in which a user logs in to the image management server 40 via the conference management server 20 will be described with reference to FIG. 10. FIG. 10 is a sequence diagram illustrating an example of a measurement process in which a user requests the image management server 40 to measure a distance between two points on an article or a property.

S1: A user inputs a login operation to the terminal device 10. This login is to log in to the conference management server 20. The input reception unit 12 of the terminal device 10 accepts the login operation. Any existing method may be used to perform the login. The following description is given on the assumption that the login is successful. When the login is successful, a session is established between the terminal device 10 and the conference management server 20. The processing between the terminal device 10 and the conference management server 20 is performed while the session is being established.

The user logs in to the conference management server 20 and then logs in to the image management server 40. Alternatively, the user may log in to the image management server 40 first and then log in to the conference management server 20.

S2: In response to a successful login, the transmission/reception unit 11 of the terminal device 10 transmits a request for a property designation screen 200 to the conference management server 20.

S3: The transmission/reception unit 21 of the conference management server 20 receives the request for the property designation screen 200. The screen generation unit 22 generates the property designation screen 200, and the transmission/reception unit 21 transmits screen information of the property designation screen 200 to the terminal device 10.

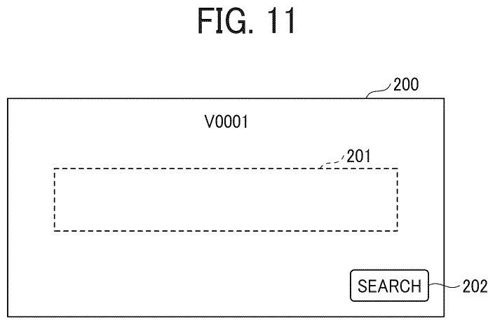

S4: The transmission/reception unit 11 of the terminal device 10 receives the screen information of the property designation screen 200. The display control unit 13 displays the property designation screen 200 (see FIG. 11). The user enters property identification information (e.g., V0001) on the displayed property designation screen 200. The input reception unit 12 of the terminal device 10 receives the property identification information.

S5: The transmission/reception unit 11 of the terminal device 10 transmits a request for speech text for which the property identification information is designated to the conference management server 20.

S6: The transmission/reception unit 21 of the conference management server 20 receives the request for speech text, and the storing/reading unit 29 searches the conference information management DB 2001 using the property identification information. The screen generation unit 22 of the conference management server 20 generates a speech text display screen 210 for displaying speech text, and the transmission/reception unit 21 transmits screen information of the speech text display screen 210 to the terminal device 10.

In response to the request for speech text, the transmission/reception unit 21 also transmits an image request program to the terminal device 10 so that the terminal device 10 can acquire three-dimensional image information. The image request program is, for example, a web application. The web application is installed in the conference management server 20 by the operator of the image management server 40 under the permission of the operator of the conference management server 20. Alternatively, a uniform resource locator (URL) at which the image request program is available may be transmitted to the terminal device 10. The web application, which is configured to acquire three-dimensional image information from the image management server 40, has a function of connecting the terminal device 10 to the image management server 40 to request or display the three-dimensional image information.

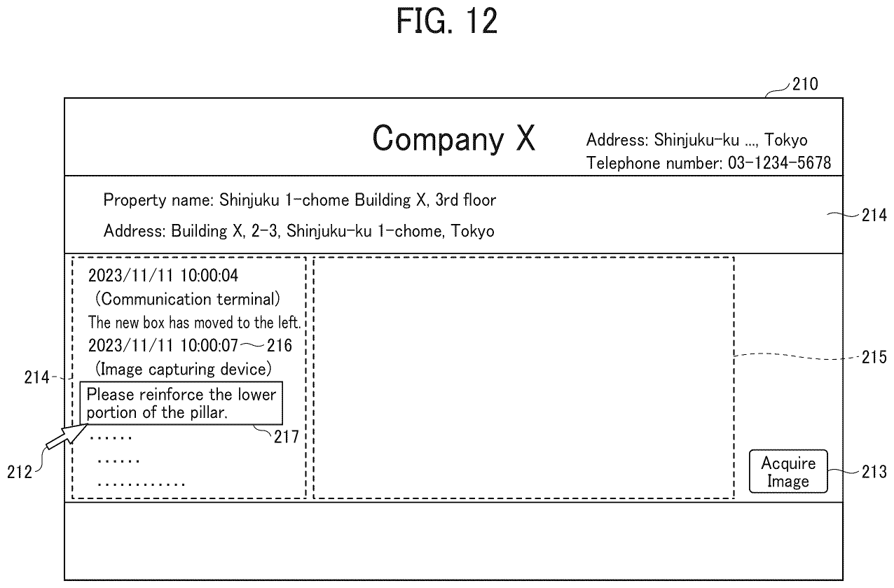

S7: The transmission/reception unit 11 of the terminal device 10 receives the screen information of the speech text display screen 210 and the image request program. The display control unit 13 displays the speech text display screen 210 (see FIG. 12). As a result, the speech text related to the property is displayed. The user performs an operation of selecting any speech text on the displayed speech text display screen 210. The user can select speech text by referring to an article name included in the speech text. Speech text is selected in order to display three-dimensional image information and a capture-generated image that are identified by the speech text. When speech text is selected, the timestamp of audio capture is also identified. The input reception unit 12 of the terminal device 10 accepts the operation of selecting speech text.

After selecting speech text, the user performs an operation of requesting a capture-generated image and three-dimensional image information of the property (e.g., pressing an image acquisition button 213). The user may be allowed to request three-dimensional image information and a capture-generated image by selecting speech text. The input reception unit 12 of the terminal device 10 accepts the operation of requesting a capture-generated image and three-dimensional image information of the property. The three-dimensional image information of the property is three-dimensional image information of articles placed in the property, which is generated as a virtual space. The articles are represented by 3D model shape information.

The speech text display screen 210 includes a first display area 214 and a second display area 215. The first display area 214 displays speech text acquired from the conference management server 20. The second display area 215 displays the capture-generated image and the three-dimensional image information of the articles acquired from the image management server 40. In step S7, the speech text is displayed in the first display area 214, whereas no information is displayed in the second display area 215.

S8: If the user has not logged in to the image management server 40, the user inputs a login operation to the terminal device 10. The login operation is to log in to the image management server 40. The input reception unit 12 of the terminal device 10 accepts the login operation. Any existing method may be used to perform the login. The following description is given on the assumption that the login is successful. The image management server 40 may omit the login operation by the user, for example, by using single sign-on. When the login is successful, a session is established between the terminal device 10 and the image management server 40. The processing between the terminal device 10 and the image management server 40 is performed while the session is being established.

S9: The terminal device 10 executes the image request program to request three-dimensional image information. Accordingly, the transmission/reception unit 11 designates the property identification information of the property selected by the user and the timestamp of audio capture and transmits a request for a capture-generated image and three-dimensional image information of the property to the image management server 40. The capture-generated image is a captured image of the same property as that of the three-dimensional image information. Preferably, the transmission/reception unit 11 transmits the URL of the conference management server 20 to the image management server 40 so that the terminal device 10 can be redirected to the conference management server 20. The three-dimensional image information of the property is an image of articles placed in the property defined as a virtual space. Since the articles are represented by 3D model shape information, the terminal device 10 projects three-dimensional model shapes of the articles into two dimensions to generate a planar image. The user can view any article while changing the point of view. The transmission/reception unit 11 may transmit the speech text acquired from the conference management server 20 to the image management server 40. For example, the image request program receives the speech text as a URL parameter from a web application connected to the conference management server 20.

S10: The transmission/reception unit 41 of the image management server 40 receives the request for a capture-generated image and three-dimensional image information of the property. The storing/reading unit 49 searches the three-dimensional image information management DB 4001 using the property identification information and acquires three-dimensional image information of each article. The storing/reading unit 49 further searches the captured image information management DB 4006 using the property identification information and acquires a capture-generated image (an example of a two-dimensional image) associated with the timestamp of image capture closest to the timestamp of audio capture, position information, and angle-of-view information. The processing unit 47 requests the screen generation unit 42 to generate a screen including the capture-generated image and the three-dimensional image information of the property. The screen generation unit 42 generates three-dimensional image information by placing a virtual camera at a position indicated by the position information and determining the angle of view of the virtual camera based on the angle-of-view information. As a result, the three-dimensional image information has the same angle of view as the capture-generated image. The screen generation unit 42 generates a screen corresponding to the second display area 215 in which the capture-generated image and the three-dimensional image information of each article are arranged on one screen.

The transmission/reception unit 41 transmits screen information of the screen corresponding to the second display area 215 to the terminal device 10. The three-dimensional image information of each article, which is included in the screen information, is three-dimensional image information in which all the articles included in the property are placed in the property, and the user can change the point of view as desired.

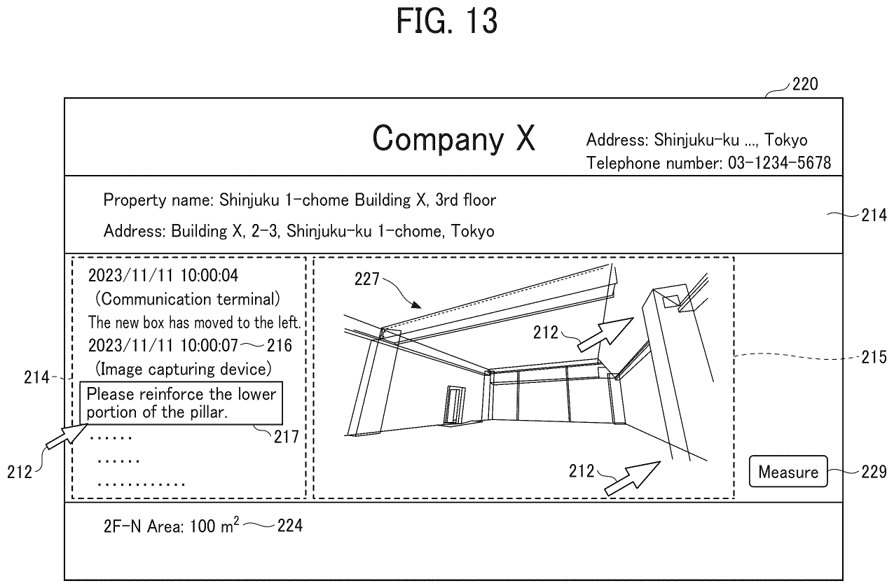

S11: The transmission/reception unit 11 of the terminal device 10 receives the screen information of the screen corresponding to the second display area 215, and the display control unit 13 displays an image display screen 220 including the first display area 214 and the second display area 215 (see FIG. 13). In step S11, the capture-generated image and the three-dimensional image information of each article are displayed in the second display area 215, and the capture-generated image and the three-dimensional image information have the same point of view. Note that the point of view is changeable for the three-dimensional image information. Subsequently, the user uses, for example, a mouse cursor 212 to designate two points between which the distance is to be measured with respect to the three-dimensional image information of the property. The input reception unit 12 of the terminal device 10 receives the coordinates of the two points on the article.

S12: In response to the user pressing a measurement button 229, the transmission/reception unit 11 of the terminal device 10 designates the coordinates of the two points and transmits a measurement request to the image management server 40.

S13: The transmission/reception unit 41 of the image management server 40 receives the measurement request. The measurement unit 51 searches the three-dimensional image information management DB 4001 based on the coordinates and identifies an article (model ID). The measurement unit 51 further searches the model shape management DB 4002 using the model ID and acquires three-dimensional model shape information of the article. The measurement unit 51 measures the distance between the two points defined by the coordinates, based on the three-dimensional model shape information.

S14: The transmission/reception unit 41 of the image management server 40 transmits the measurement result (i.e., the distance between the two points defined by the coordinates) to the terminal device 10.

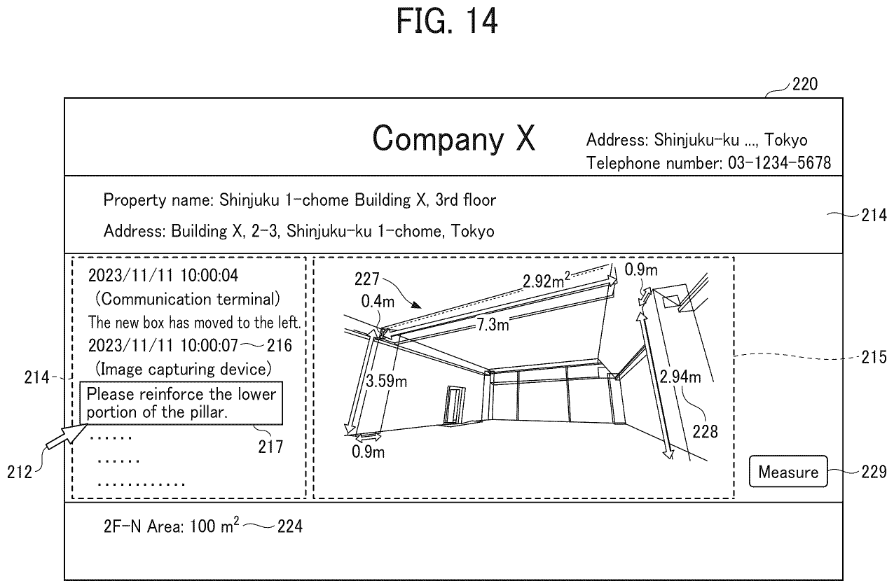

S15: The transmission/reception unit 11 of the terminal device 10 receives the measurement result, and the display control unit 13 displays the measurement result together with the three-dimensional image information of the property (see FIG. 14).

### Example Screens

FIG. 11 illustrates an example of the property designation screen 200 for inputting property identification information. The property designation screen 200 includes a property identification information input field 201 and a search button 202. In response to the user entering property identification information in the property identification information input field 201 and pressing the search button 202, the speech text display screen 210 illustrated in FIG. 12 is displayed.

FIG. 12 illustrates an example of the speech text display screen 210. The speech text display screen 210 includes a first display area 214 and a second display area 215. The first display area 214 displays speech text acquired from the conference management server 20. The second display area 215 displays the three-dimensional image information or the like of the articles acquired from the image management server 40. The first display area 214 is an area other than the second display area 215. The first display area 214 includes speech text captured during a conference regarding the property identified by the property identification information. The user uses the mouse cursor 212 to select speech text 217 related to an article for which the capture-generated image is to be displayed. When speech text is selected, a timestamp of audio capture 216 is also identified. In response to the user pressing the image acquisition button 213, the image display screen 220 illustrated in FIG. 13 is displayed.

While the second display area 215 is an area other than the first display area 214, display may be implemented by a program on a web application such as an iframe.

FIG. 13 is a diagram illustrating an example of the image display screen 220. The image display screen 220 includes the first display area 214 and the second display area 215. The first display area 214 is similar to that illustrated in FIG. 12. The second display area 215 displays three-dimensional image information 227 of articles. The user uses the mouse cursor 212 to designate two points between which the distance is to be measured. In FIG. 13, two points on the wall are designated. In response to the user pressing the measurement button 229, the image management server 40 starts the measurement of the distance between the two points.

The image display screen 220 also displays a size (floor area) 224 as information related to the property. The size (floor area) 224 may be a measured value or may be included in speech text.

The screen as illustrated in FIG. 13 on which speech text and the three-dimensional image information 227 of the property are displayed is an example of a first display screen.

FIG. 14 illustrates the image display screen 220 on which measurement results are displayed. As can be seen from comparison with FIG. 13, a distance 228 between two points is displayed as a measurement result.

As described above, in a case where the user logs in to the image management server 40 via the conference management server 20, the terminal device 10 can display speech text and three-dimensional image information of the property on a single screen. The user can perform work using the three-dimensional image information of the property, such as measurement of the distance 228 between the two points, while viewing the speech text.

### Direct Login to Image Management Server

Next, a case in which the user logs in directly to the image management server 40 to measure a distance between two points will be described.

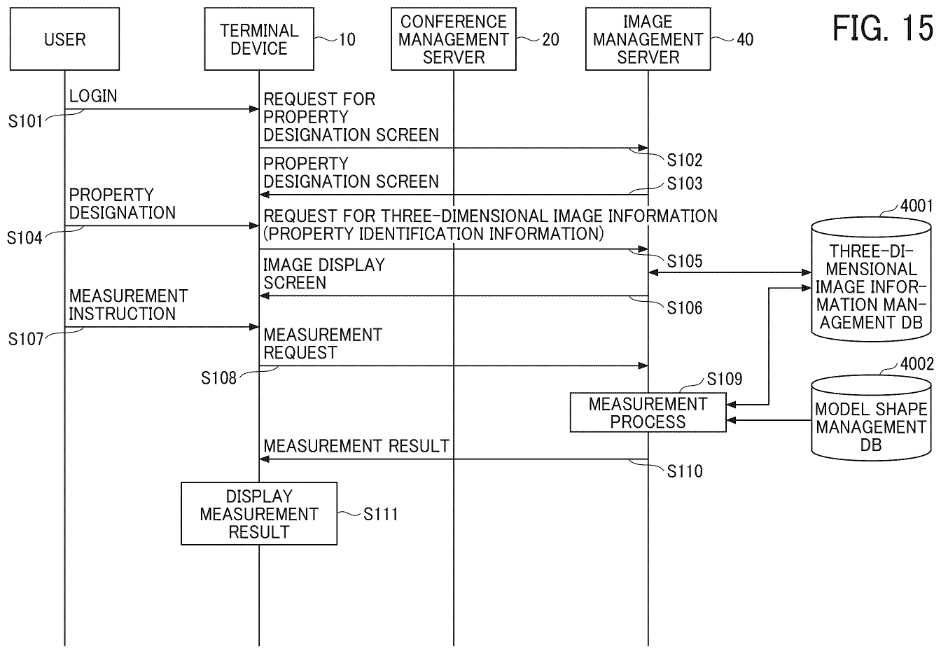

FIG. 15 is a sequence diagram illustrating an example of a measurement process in which a user requests the image management server 40 to measure a distance between two points on an article or a property.

S101: A user inputs a login operation to the terminal device 10. This login is to log in to the image management server 40. The input reception unit 12 of the terminal device 10 accepts the login operation. Any existing method may be used to perform the login. The following description is given on the assumption that the login is successful.

S102: In response to a successful login, the transmission/reception unit 11 of the terminal device 10 transmits a request for the property designation screen 200 to the image management server 40.

S103: The transmission/reception unit 41 of the image management server 40 receives the request for the property designation screen 200. The screen generation unit 42 generates the property designation screen 200, and the transmission/reception unit 41 transmits screen information of the property designation screen 200 to the terminal device 10.

S104: The transmission/reception unit 11 of the terminal device 10 receives the screen information of the property designation screen 200. The display control unit 13 displays the property designation screen 200 (see FIG. 11). The user enters property identification information (e.g., V0001) on the displayed property designation screen 200. The input reception unit 12 of the terminal device 10 receives the property identification information.

S105: The transmission/reception unit 11 of the terminal device 10 transmits a request for three-dimensional image information of the property for which the property identification information is designated to the image management server 40. Since the terminal device 10 has not logged in to the conference management server 20, the speech text display screen 210 illustrated in FIG. 12 is not displayed.

S106: The transmission/reception unit 41 of the image management server 40 receives the request, and the storing/reading unit 49 searches the three-dimensional image information management DB 4001 using the property identification information. The storing/reading unit 49 acquires three-dimensional image information of each article. A capture-generated image, position information, and angle-of-view information are not acquired from the captured image information management DB 4006 since a timestamp of audio capture is not transmitted.

The screen generation unit 42 generates an image display screen 320 on which the three-dimensional image information of each article is arranged. The transmission/reception unit 41 transmits screen information of the image display screen 320 to the terminal device 10. The three-dimensional image information of each article is three-dimensional image information in which all the articles included in the property are placed in the property, and the user can change the point of view as desired.

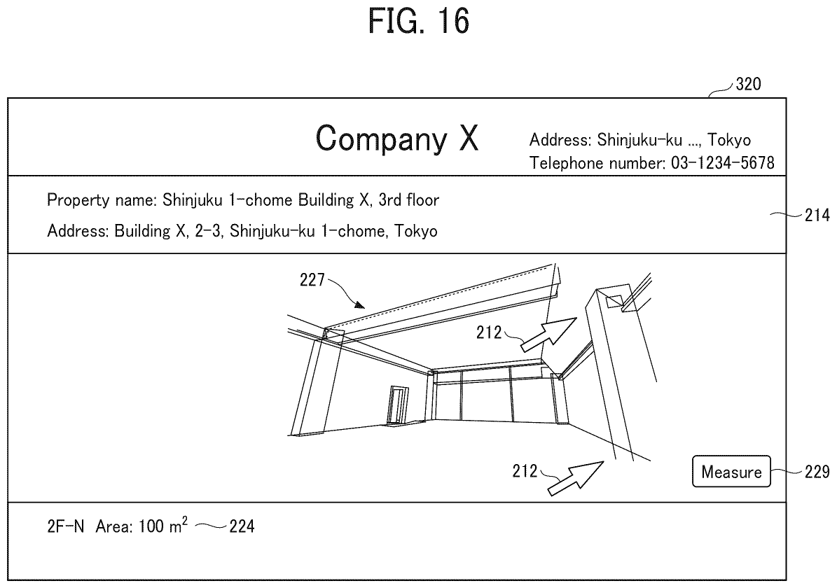

S107: The transmission/reception unit 11 of the terminal device 10 receives the screen information of the image display screen 320, and the display control unit 13 displays the image display screen 320 (see FIG. 16). In the process illustrated in FIG. 15, the terminal device 10 has not logged in to the conference management server 20. Thus, the image display screen 320 does not display speech text related to the property. The screen generation unit 42 may use the three-dimensional image information management DB 4001, which is managed by the image management server 40, to generate a screen displaying information equivalent to the speech text. Subsequently, the user uses a mouse cursor or the like to designate two points between which the distance is to be measured with respect to the three-dimensional image information of the property. The input reception unit 12 of the terminal device 10 receives the coordinates of the two points on the article.

S108: In response to the user pressing the measurement button 229, the transmission/reception unit 11 of the terminal device 10 designates the coordinates of the two points and transmits a measurement request to the image management server 40.

S109: The transmission/reception unit 41 of the image management server 40 receives the measurement request. The measurement unit 51 searches the three-dimensional image information management DB 4001 based on the coordinates and identifies an article (model ID). The measurement unit 51 further searches the model shape management DB 4002 using the model ID and acquires three-dimensional model shape information of the article. The measurement unit 51 measures the distance between the two points defined by the coordinates, based on the three-dimensional model shape information.

S110: The transmission/reception unit 41 of the image management server 40 transmits the measurement result (i.e., the distance between the two points) to the terminal device 10.

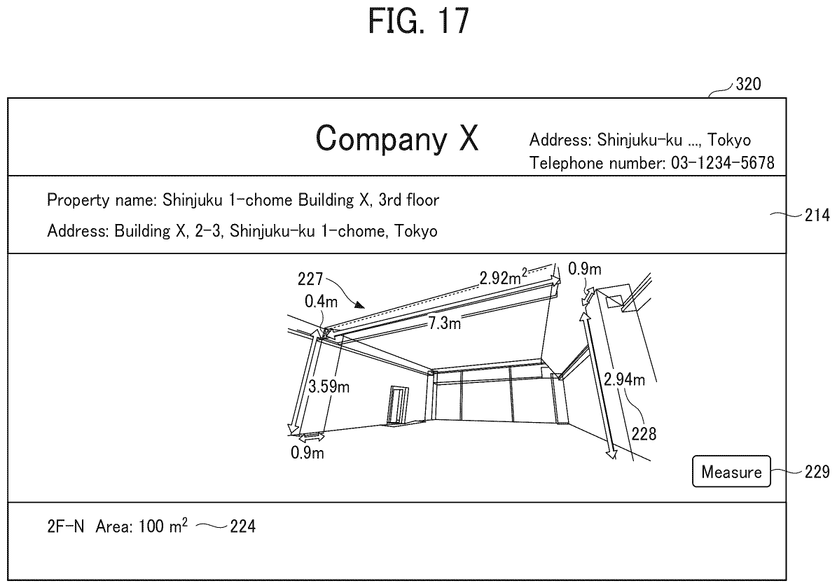

S111: The transmission/reception unit 11 of the terminal device 10 receives the measurement result, and the display control unit 13 displays the measurement result on the image display screen 320 (see FIG. 17).

### Example Screens

The property designation screen 200 may be similar to that illustrated in FIG. 11. In a case where the user has logged in directly to the image management server 40, the speech text display screen 210 illustrated in FIG. 12 is not displayed.

FIG. 16 illustrates the image display screen 320 including the three-dimensional image information of the property. As compared with FIG. 13, the speech text is not displayed. This is because the speech text is managed by the conference management server 20. The way in which the user designates the coordinates of two points may be similar to that illustrated in FIG. 13.

The screen as illustrated in FIG. 16 on which the speech text is not displayed and the three-dimensional image information 227 of the property is displayed is an example of a second display screen.

FIG. 17 illustrates the image display screen 320 on which measurement results are displayed. As compared with FIG. 14, the speech text is not displayed. This is because the speech text is managed by the conference management server 20. The distance 228 between the two points, which is a measurement result, is the same as that illustrated in FIG. 14.

As described above, in a case where the user has logged in directly to the image management server 40, the terminal device 10 displays the three-dimensional image information 227 of the property. Thus, if the user is not authorized to use the conference management server 20, the image management server 40 can restrict the information managed by the conference management server 20 from being provided to the user.

According to the present embodiment, the image management server 40 performs processing in response to a user logging in to the first server, and performs processing in response to the user logging in to the second server. That is, the terminal device 10 can change the information to be displayed on a single screen depending on whether the user has logged in to the image management server 40 directly or via the conference management server 20. If the user is not authorized to use the conference management server 20, the image management server 40 can restrict the information managed by the conference management server 20 from being provided to the user. In addition, the image management server 40 can provide the same measurement result to the user regardless of whether the user has logged in to the image management server 40 directly or via the conference management server 20.

### Second Embodiment

A second embodiment of the present disclosure describes an information processing system 100 that selectively uses the first tacit knowledge model 4004A and the second tacit knowledge model 4004B depending on whether a user has logged in to the image management server 40 via the conference management server 20 or has logged in directly to the image management server 40.

In the present embodiment, reference is also made to the hardware configuration diagram of FIG. 2 and the functional block diagram of FIG. 3, which have been described in the first embodiment.

### Operations or Processes

### Login to Image Management Server via Conference Management Server

First, a case in which a user logs in to the image management server 40 via the conference management server 20 will be described. Further, a model update process in which the first tacit knowledge model 4004A is trained on data will be described.

### Learning Phase (Model Update)

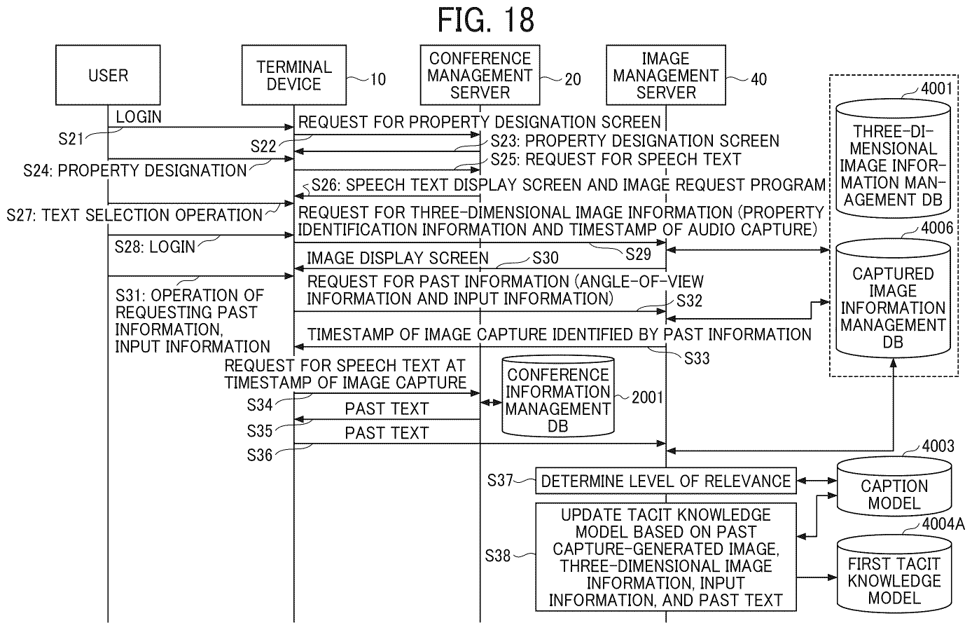

FIG. 18 is a sequence diagram illustrating an example of the model update process. The processing of steps S21 to S30 may be similar to that of steps S1 to S10 in FIG. 10.

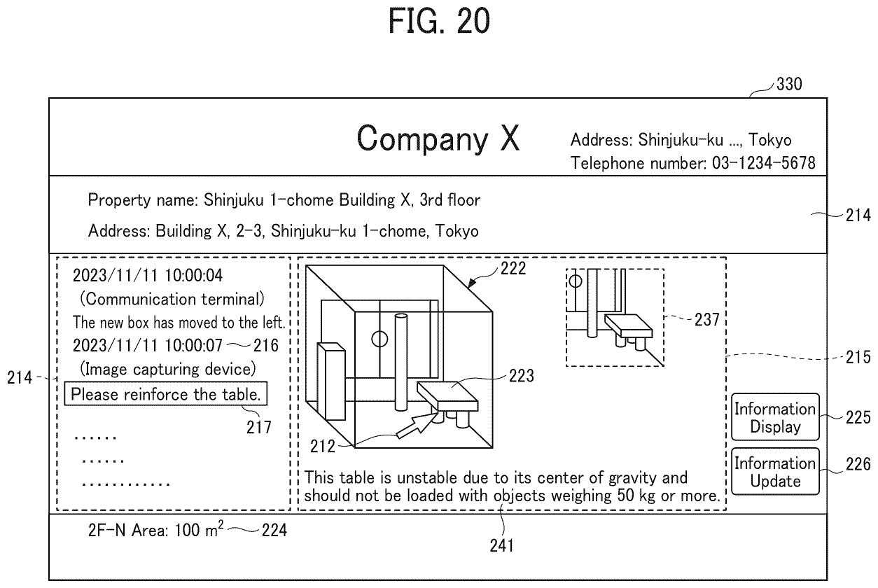

S31: The transmission/reception unit 11 of the terminal device 10 receives the screen information of the screen corresponding to the second display area 215, and the display control unit 13 displays an image display screen 330 including the first display area 214 and the second display area 215 (see FIG. 20). The first display area 214 displays speech text. The second display area 215 displays the three-dimensional image information of the property. Thus, speech text obtained at a specified timestamp of audio capture and a capture-generated image captured at the timestamp closest to the timestamp of audio capture are displayed together with the three-dimensional image information on a single screen.

Subsequently, the user identifies any article from the three-dimensional image information of the property. When the user identifies an article, the user can request updating of a tacit knowledge model for the article. The input reception unit 12 of the terminal device 10 accepts the operation of identifying the article. The article may be identified by, for example, the coordinates of a position clicked by the user, or a model ID may be identified using the coordinates.

The user can change the point of view of the three-dimensional image information and enlarge an article. The user performs an operation of requesting past information. The past information includes a capture-generated image older than the capture-generated image displayed in step S31 (the older capture-generated image is hereinafter referred to as a past capture-generated image) and speech text older than the selected speech text. For example, the user may press an information display button 225 to perform an operation of requesting past information. The input reception unit 12 of the terminal device 10 accepts the operation of requesting past information. The user may be allowed to specify a specific past timestamp. While past information is requested in the present embodiment, the user may be allowed to request information later than the speech text selected in step S27.

The user inputs comments related to the article, such as the comments (character information or voice) described with reference to FIGS. 8A, 8B, 9A, and 9B, to the terminal device 10. The comments may be referred to as input information. The comments may be tacit knowledge comments. The comments may include a caption comment describing the article.

S32: In response to the user pressing the information display button 225, the transmission/reception unit 11 of the terminal device 10 transmits a request for past information for which angle-of-view information is designated to the image management server 40. The angle-of-view information indicates an angle of view designated by the user for the three-dimensional image information. Thus, updating of a tacit knowledge model using past information is requested. Further, the coordinates of a position clicked by the user with a mouse cursor or the model ID of an article identified by the coordinates is transmitted to the image management server 40.

S33: The transmission/reception unit 41 of the image management server 40 receives the request for past information. The storing/reading unit 49 searches the captured image information management DB 4006 and identifies the angle-of-view information closest to the received angle-of-view information among items of angle-of-view information older than the timestamp of audio capture transmitted in step S29. The storing/reading unit 49 acquires the timestamp of image capture associated with the identified angle-of-view information. It may not be possible to find exactly the same angle-of-view information as the received angle-of-view information in the captured image information management DB 4006. Accordingly, the storing/reading unit 49 searches the captured image information management DB 4006 and identifies angle-of-view information indicating an angle of view having a difference within a certain range. A range indicating how far back in time to search may be set in advance. When a plurality of items of angle-of-view information match, the storing/reading unit 49 identifies the latest item of angle-of-view information. The user may be allowed to set the range of difference and the range indicating how far back in time to search.

The storing/reading unit 49 further acquires a capture-generated image (i.e., past capture-generated image) associated with the timestamp of image capture from the captured image information management DB 4006.

The transmission/reception unit 41 of the image management server 40 transmits the timestamp of image capture identified by the angle-of-view information to the terminal device 10.

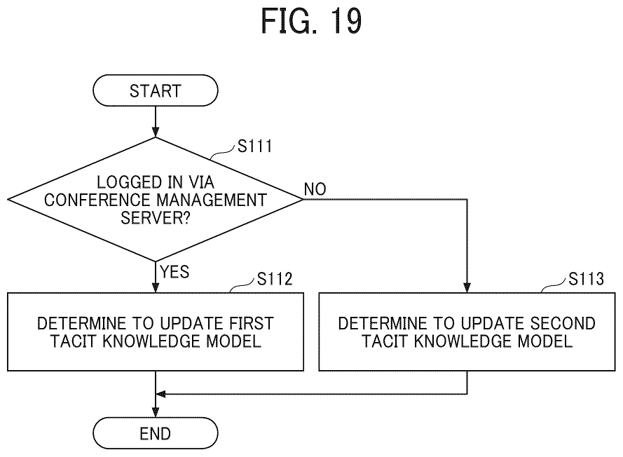

The determination unit 48 determines which of the first tacit knowledge model 4004A and the second tacit knowledge model 4004B is to be updated. Since a login from the image request program, which is used for a login to the conference management server 20, is accepted in step S28, the determination unit 48 determines that a login to the image management server 40 has been performed via the conference management server 20. Thus, the determination unit 48 determines to update the first tacit knowledge model 4004A. A process in which the determination unit 48 determines a model to be updated will be described with reference to FIG. 19.

S34: The transmission/reception unit 21 of the conference management server 20 receives the request for speech text, and the storing/reading unit 29 searches the conference information management DB 2001 for a timestamp of audio capture by using the received timestamp of image capture. The storing/reading unit 29 acquires, from the conference information management DB 2001, the speech text at the corresponding timestamp (image capturing device) and the speech text at the corresponding timestamp (communication terminal) associated with a timestamp of audio capture that is the same as or the closest to the timestamp of image capture. Such speech text is hereinafter referred to as past text (an example of second text data).

S35: The transmission/reception unit 21 transmits the past text to the terminal device 10.

S36: In response to receiving the past text, the transmission/reception unit 11 of the terminal device 10 transmits the past text to the image management server 40. The transmission/reception unit 41 of the image management server 40 receives the past text as a response to the request in step S33. The storing/reading unit 49 stores the past text in the captured image information management DB 4006 in association with the timestamp of image capture identified in step S33. Accordingly, the speech text is associated with the capture-generated image.

S37: In response to receipt of the past text, the update unit 46 updates a tacit knowledge model. First, the decision unit 43 acquires a caption comment identified by the model ID from the caption model 4003, and determines a level of relevance of the caption comment to the comment included in the input information received in step S32 and the past text received in step S36. The decision unit 43 may determine a level of relevance of the acquired caption comment to the entire comment included in the input information received in step S32 and the entire past text received in step S36. Alternatively, the decision unit 43 may divide the comment included in the input information received in step S32 and the entire text received in step S36 into multiple comments and multiple pieces of past text and determine a level of relevance of the acquired caption comment to each of the divided comments and each of the divided pieces of past text.

S38: The update unit 46 updates the caption model 4003 by associating a comment determined to have a high level of relevance in step S37, as a caption comment, with the model ID. The update unit 46 further updates the first tacit knowledge model 4004A determined by the determination unit 48. The update unit 46 updates the first tacit knowledge model 4004A using, as training data, a comment and past text determined to have a low level of relevance in step S37, and the three-dimensional image information (identified in step S32) and a past capture-generated image of an article related to the comment and the past text. That is, the correspondences among the three-dimensional image information and the past capture-generated image of the article, the comment, and the past text are learned. Features of the three-dimensional image information and the past capture-generated image of the article are extracted using some feature extraction models suitable for images, such as CNN models. The features represent, for example, objects that appear in an image and positions of the objects appearing in the image, or operations that are being performed in the image. Thus, the first tacit knowledge model 4004A can learn the correspondences among the features of the three-dimensional image information and the past capture-generated image of the article, the comment, and the past text.

Both the comment and the past text are not to be used, and the first tacit knowledge model 4004A may be used using at least either the comment or the past text.

FIG. 19 is a flowchart illustrating a process in which the determination unit 48 determines whether to update the first tacit knowledge model 4004A or the second tacit knowledge model 4004B. In FIG. 19, the determination unit 48 determines whether a login to the image management server 40 has been performed via the conference management server 20 (step S111-1). The determination unit 48 can determine whether a login to the image management server 40 has been performed via the conference management server 20, based on whether the login is a login using the image request program distributed from the conference management server 20.

If the determination in step S111-1 is “YES”, the determination unit 48 determines to update the first tacit knowledge model 4004A (step S112).

If the determination in step S111-1 is “NO”, the determination unit 48 determines to update the second tacit knowledge model 4004B (step S113).

While model updating is illustrated as an example in FIG. 19, the illustrated process is also applicable to selection of a model to be used to generate text information.

### Example Screens

The property designation screen 200 in the learning phase may be similar to that illustrated in FIG. 11, and the speech text display screen 210 in the learning phase may be similar to that illustrated in FIG. 12. In contrast, in place of the image display screen 220 illustrated in FIG. 13, a screen as illustrated in FIG. 20 is displayed.

FIG. 20 illustrates the image display screen 330 including speech text and three-dimensional image information. The image display screen 330 includes the first display area 214 and the second display area 215, and the first display area 214 of the image display screen 330 displays speech text and the size (floor area) 224. The second display area 215 of the image display screen 330 displays three-dimensional image information 222 of articles in the property, such as three-dimensional image information 223 of a table. The second display area 215 further displays a capture-generated image 237. The capture-generated image 237 is a capture-generated image (stored in the image management server 40) captured at the date and time closest to the timestamp of audio capture 216 associated with the selected speech text 217. In an initial state, the three-dimensional image information 222 has the same image capturing position and the same angle of view as the capture-generated image 237. Since the three-dimensional image information 222 is a wide-view image, the user can change the angle-of-view information of the three-dimensional image information 222.

Further, in order to use a past capture-generated image of a desired article for updating, the user operates the three-dimensional image information 222 to designate an angle of view at which the desired article (point of view) is to be displayed. For example, the user designates an angle of view for enlarging the three-dimensional image information 223 of the table.

Further, the user selects the three-dimensional image information 223 of the table with the mouse cursor 212, and enters input information 241, which may be a tacit knowledge comment. As a result, the input information 241 is displayed in the second display area 215 in association with the three-dimensional image information 223 of the table. The input information 241 states: “This table is unstable due to its center of gravity and should not be loaded with objects weighing 50 kg or more”. The image management server 40 can update the first tacit knowledge model 4004A using the input information 241 and the past text. The size (floor area) 224 may be a caption comment as information related to the property.

In response to the user pressing an information update button 226, the first tacit knowledge model 4004A is updated. In response to the information display button 225 being pressed, text information is generated based on a tacit knowledge comment generated by the first tacit knowledge model 4004A.

### Inference Phase (Text Information Generation)

Next, a text information generation process using the first tacit knowledge model 4004A will be described.

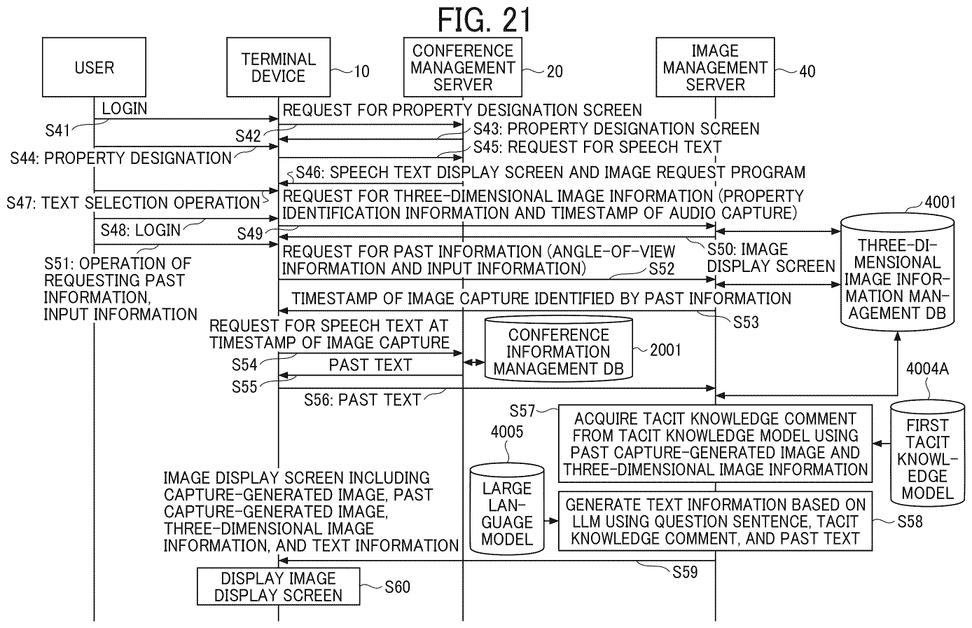

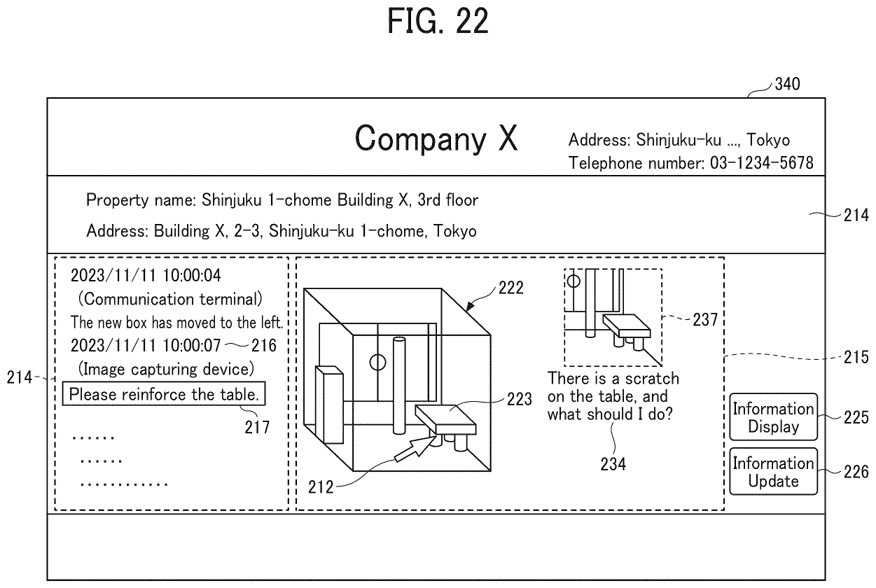

FIG. 21 is a sequence diagram illustrating an example of the text information generation process. In the description of FIG. 21, differences from FIG. 18 may be described. The processing of steps S41 to S56 may be similar to that of steps S21 to S36 in FIG. 18. Note that, in step S51, the user enters a question sentence and then presses the information display button 225 (see FIG. 22).

S57: The determination unit 48 determines which of the first tacit knowledge model 4004A and the second tacit knowledge model 4004B is to be used to generate text information. Since a login from the image request program, which is used for a login to the conference management server 20, is accepted in step S48, the determination unit 48 determines that a login to the image management server 40 has been performed via the conference management server 20. Thus, the determination unit 48 determines to use the first tacit knowledge model 4004A to generate text information.

The processing unit 47 requests the text information generation unit 45 to generate text information. The text information generation unit 45 acquires a tacit knowledge comment corresponding to the three-dimensional image information and the past capture-generated image of the article from the first tacit knowledge model 4004A. The first tacit knowledge model 4004A can extract features of the three-dimensional image information and the past capture-generated image of the article and identify at least either the input information or the past text corresponding to the features as a tacit knowledge comment. The three-dimensional image information of the article is the three-dimensional image information of the article identified by the user in step S51. The user may designate three-dimensional image information of a plurality of articles or all of the articles.

S58: Subsequently, the text information generation unit 45 acquires text information created by the large language model 4005 using the tacit knowledge comment, the input information (question sentence), and the past text. The large language model 4005 can generate more detailed text information using the tacit knowledge comment, the input information (question sentence), and the past text. The text information generated by the text information generation unit 45 may be either voice information or character information.

The text information generation unit 45 may generate text information without using any input information and past text at all. Alternatively, the text information generation unit 45 may generate a fixed question within the information processing system 100 in advance and use the fixed question to generate text information. In this case, the question sentence is invisible to the user. Alternatively, the text information generation unit 45 may generate fixed questions within the information processing system 100 in advance, which are then displayed on the display unit to prompt the user to select any of the fixed questions, and use the selected question.

As described above, input information or past text is optional. However, using input information or past text to generate text information from the large language model 4005 provides more detailed information related to an article. For example, when input information or past text includes the severity of a scratch on an article, text information including appropriate measures to be taken in accordance with the severity of the scratch can be generated.

S59: The processing unit 47 requests the screen generation unit 42 to generate a screen displaying the capture-generated image displayed on the screen in step S50, the three-dimensional image information with the angle of view received in step S52, the past capture-generated image identified in step S53, and the text information in association with one another. The screen generation unit 42 generates a screen corresponding to the second display area 215 for displaying the three-dimensional image information, the capture-generated image, the past capture-generated image, and the generated text information.

The screen generation unit 42 may perform an update process for adding only the text information to the screen corresponding to the second display area 215. The transmission/reception unit 41 of the image management server 40 transmits screen information of the screen corresponding to the second display area 215 to the terminal device 10. The transmission/reception unit 11 of the terminal device 10 receives the screen information of the screen corresponding to the second display area 215 transmitted from the image management server 40.

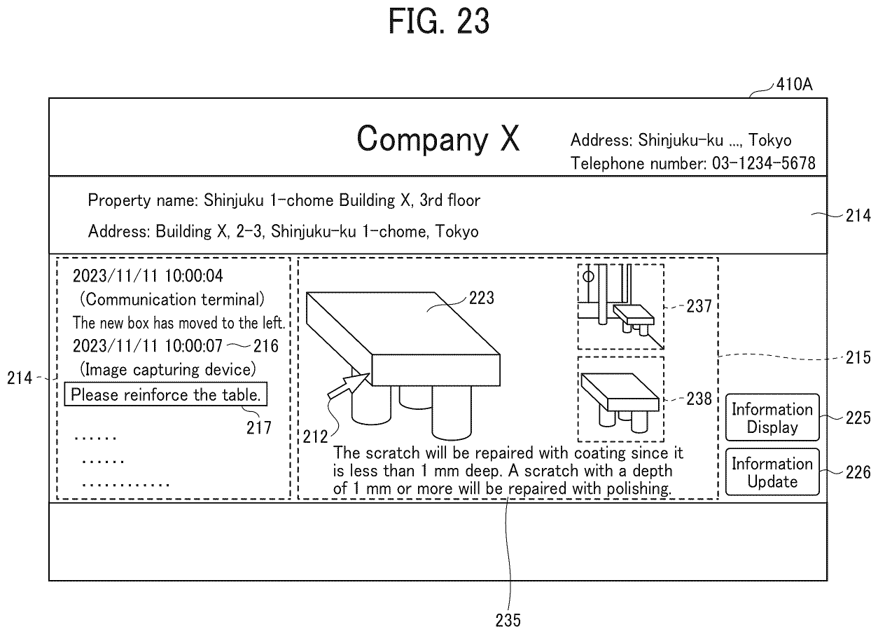

S60: The display control unit 13 of the terminal device 10 displays an image display screen 410A (see FIG. 23) including the first display area 214 and the second display area 215 that includes, for example, the text information. Alternatively, the conversion unit 15 converts the received text information into voice information, and the audio control unit 14 controls the speaker 109a to reproduce the converted text information. When the received text information is voice information, the text information is reproduced by the speaker 109a, or the conversion unit 15 converts the received text information into character information and the display 106a displays the converted text information.

### Example Screens in Inference Phase

Of the screens to be displayed on the terminal device 10 in the inference phase, the property designation screen 200 may be similar to that illustrated in FIG. 11, and the speech text display screen 210 may be similar to that illustrated in FIG. 12. In contrast, in place of the image display screen 220 illustrated in FIG. 13, a screen as illustrated in FIG. 22 is displayed.

FIG. 22 illustrates an example of an image display screen 340 in the inference phase. The image display screen 340 includes the first display area 214 and the second display area 215. The image display screen 340 illustrated in FIG. 22 has substantially the same configuration as the image display screen 330 illustrated in FIG. 20, except that the user enters a question sentence 234 as input information. The second display area 215 displays the input information (the question sentence 234) in association with the three-dimensional image information 223 of the table. For example, the question sentence 234 illustrated in FIG. 22 states, “There is a scratch on the table, and what should I do?” The user presses the information display button 225 to make a request to generate text information using a tacit knowledge model, together with the question sentence 234. Accordingly, the text information generation unit 45 generates text information using the first tacit knowledge model 4004A and the large language model 4005.

The screen as illustrated in FIG. 22 on which speech text and the three-dimensional image information 222 of the property are displayed is an example of a first display screen.

FIG. 23 illustrates an example of the image display screen 410A including text information. The image display screen 410A includes the first display area 214 and the second display area 215. In FIG. 23, the three-dimensional image information 223 of the table is displayed since the user has requested a tacit knowledge comment by pressing the three-dimensional image information 223 of the table with the mouse cursor 212. The image display screen 410A further includes text information 235. The text information 235 is displayed in the second display area 215 in association with the three-dimensional image information 223 of the table. Text information 235 states, “The scratch will be repaired with coating since it is less than 1 mm deep. A scratch with a depth of 1 mm or more will be repaired with polishing”. The text information 235 is generated by the large language model 4005, based on the tacit knowledge comment, the past text, and the question sentence. For example, when a scratch is detected in a capture-generated image or past capture-generated image of an article, a tacit knowledge comment related to the scratch on the article is extracted. The tacit knowledge comment, the question sentence related to the scratch, and past text that specifies the current state of the scratch are input to the large language model 4005, and thus text information appropriate for a question related to the current state of the scratch can be generated.

### Generation of Text Information Using Past Text

1. Comparative Example 1 (Case of Using General Large Language Model)
Question sentence: The user asks a question, “How should I repair a crack?”
Tacit knowledge comment: You can use tape or filler to repair it.
2. Comparative Example 2 (Case of Learning from Three-Dimensional Image Information)
Learning Phase
Training data: While displaying a three-dimensional image, the user asks a question, “How should I repair a crack?”
Input information: Please use tape for a large width crack and filler for a small width crack.
Inference Phase
Input image: Three-dimensional image information
Question sentence: “How should I repair a crack?”
Tacit knowledge comment: There are a large width crack and a small width crack, so the use of tape is recommended for the large width crack and the use of filler is recommended for the small width crack.
3. Present Embodiment (Three-Dimensional Image Information, Past Capture-Generated Image, and Past Text)
Learning Phase
Input image: Three-dimensional image information and a past capture-generated image
Past text: When tape is applied to the corner, a crack may occur.
Inference Phase
Input image: Three-dimensional image information and a past capture-generated image
Question sentence: “How should I repair a crack?”
Tacit knowledge comment: There are a large width crack and a small width crack, so the use of tape is recommended for the large width crack and the use of filler is recommended for the small width crack. Please be careful when applying tape to the corner, as a crack may occur.
That is, an effect obtained by learning from the past text is the comment, stating “Please be careful when applying tape to the corner, as a crack may occur”.
4. Present Embodiment (Three-Dimensional Image Information, Past Capture-Generated Image, Past Text, and Input Information)
Learning Phase
Input image: Three-dimensional image information and a past capture-generated image
Past text: When tape is applied to the corner, a crack may occur.
Input information: A large width crack extends across the corner.
Inference Phase
Input image: Three-dimensional image information and a past capture-generated image
Question sentence: “How should I repair a crack?”

Tacit knowledge comment: There are a large width crack and a small width crack, so the use of tape is recommended for the large width crack and the use of filler is recommended for the small width crack. Please be careful when applying tape to the corner, as a crack may occur.

That is, an effect obtained by learning from the past text is the comment, stating “Please be careful when applying tape to the corner, as a crack may occur”.

### Direct Login to Image Management Server

Next, a case in which the user logs in directly to the image management server 40 will be described. Further, a model update process in which the second tacit knowledge model 4004B is trained on data will be described.

### Learning Phase (Model Update)

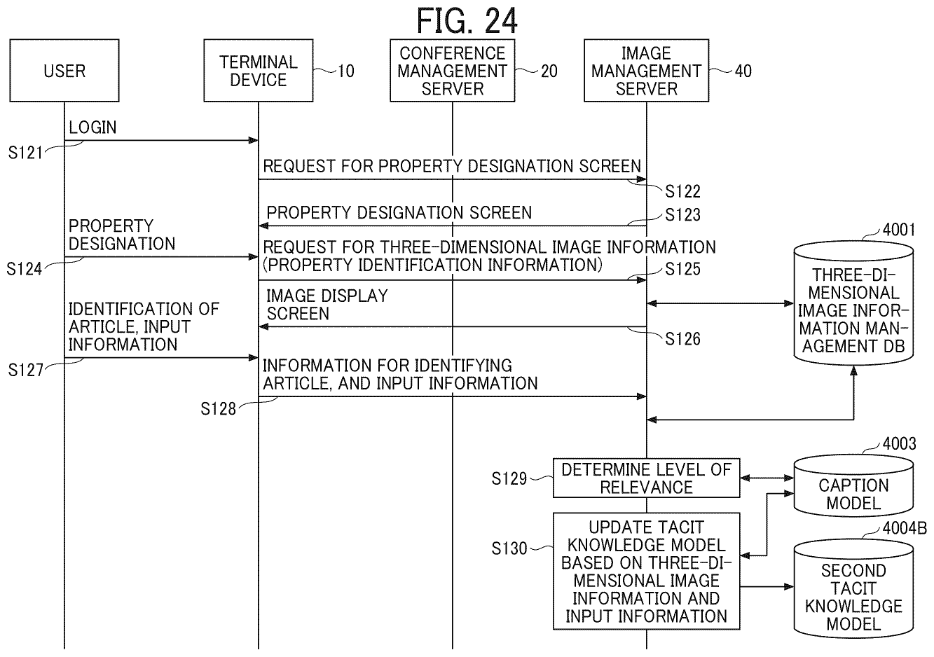

FIG. 24 is a sequence diagram illustrating an example of the model update process. The processing of steps S121 to S126 may be similar to that of steps S101 to S106 in FIG. 15.

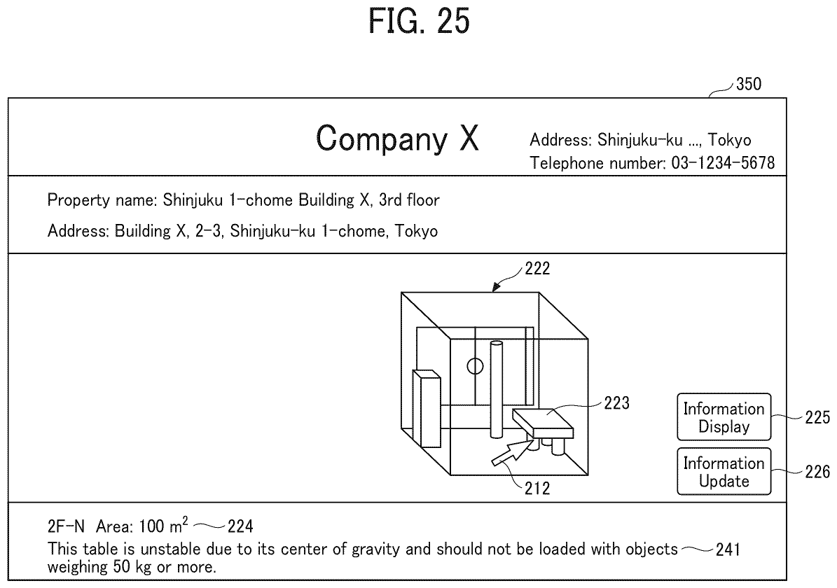

S127: The transmission/reception unit 11 of the terminal device 10 receives screen information of an image display screen 350, and the display control unit 13 displays the image display screen 350 (see FIG. 25). In the present embodiment, the terminal device 10 has not logged in to the conference management server 20. Thus, speech text managed by the conference management server 20 is not displayed. The screen generation unit 42 may use the captured image information management DB 4006, which is managed by the image management server 40, to generate a screen displaying information equivalent to the speech text. Subsequently, the user identifies any article from the three-dimensional image information of the property. When the user identifies an article, the user can request updating of a tacit knowledge model. The input reception unit 12 of the terminal device 10 accepts the operation of identifying the article. The article may be identified by, for example, the coordinates of a position clicked by the user, or a model ID may be identified using the coordinates.

The user inputs comments related to the article, such as the comments (character information or voice) described with reference to FIGS. 8A, 8B, 9A, and 9B, to the terminal device 10. The comments may be referred to as input information. The comments may be tacit knowledge comments. The comments may include a caption comment describing the article.

S128: In response to the user pressing the information update button 226, the transmission/reception unit 11 of the terminal device 10 transmits a notification that the information update button 226 has been pressed, information for identifying the article, and the input information to the image management server 40. The transmission/reception unit 41 of the image management server 40 receives the notification, the information for identifying the article, and the input information. The determination unit 48 determines which of the first tacit knowledge model 4004A and the second tacit knowledge model 4004B is to be updated. Since the determination unit 48 determines that the login in step S121 is not a login using the image request program distributed from the conference management server 20, the determination unit 48 determines to update the second tacit knowledge model 4004B.

S129: The decision unit 43 acquires a caption comment identified by the model ID from the caption model 4003, and determines a level of relevance between the caption comment and a comment included in the input information received in step S128. In one example, the decision unit 43 may determine the level of relevance of the entire comment included in the input information received in step S128 to the acquired caption comment. In another example, the decision unit 43 may divide the comment included in the input information received in step S128 into multiple comments and determine a level of relevance of each of the divided comments to the acquired caption comment.

S130: The update unit 46 updates the caption model 4003 by associating a comment determined to have a high level of relevance in step S129, as a caption comment, with the model ID (identified in step S127). The update unit 46 also updates the second tacit knowledge model 4004B using, as training data, a comment determined to have a low level of relevance in step S129 and three-dimensional image information (identified in step S128) of an article related to the comment. That is, the correspondence between the three-dimensional image information of the article and the comment is learned. Features of the three-dimensional image information of the article are extracted using some feature extraction models suitable for images, such as CNN models. The features represent, for example, objects that appear in an image and positions of the objects appearing in the image, or operations that are being performed in the image. Thus, the second tacit knowledge model 4004B can learn the correspondence between the features of the three-dimensional image information of the article and the comment.

### Example Screens

The property designation screen 200 to be displayed on the terminal device 10 in the learning phase may be similar to that illustrated in FIG. 11. The speech text display screen 210 illustrated in FIG. 12, which is a screen generated by the conference management server 20, is not displayed. The image display screen 350 according to the present embodiment will be described with reference to FIG. 25.

FIG. 25 illustrates the image display screen 350 according to the present embodiment. As compared with FIG. 20, speech text is not displayed in FIG. 25. This is because the terminal device 10 has logged in directly to the image management server 40. Also, the capture-generated image 237 is not displayed in FIG. 25. This is because the speech text 217 has not been selected. The user enters the input information 241, which can be a tacit knowledge comment, and then presses the information update button 226. As a result, the image management server 40 starts the update of the second tacit knowledge model 4004B.

The screen as illustrated in FIG. 25 on which speech text is not displayed and the three-dimensional image information 222 of the property is displayed is an example of a second display screen.

Inference Phase (text Information Generation)

Next, a text information generation process using the second tacit knowledge model 4004B will be described.

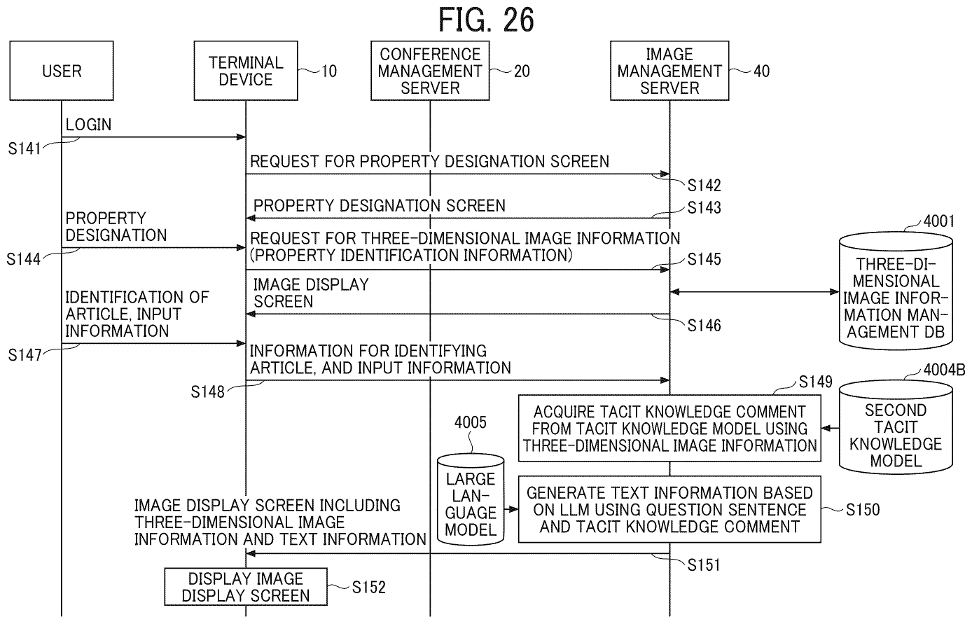

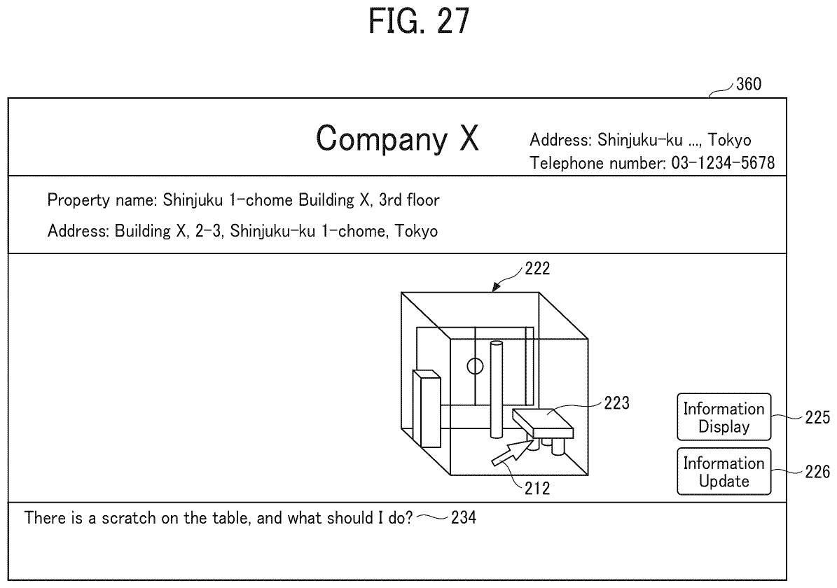

FIG. 26 is a sequence diagram illustrating an example of the text information generation process. In the description of FIG. 26, differences from FIG. 24 may be described. The processing of steps S141 to S148 may be similar to that of steps S121 to S128 in FIG. 24. Note that, in step S147, the user enters a question sentence and then presses the information display button 225 (see FIG. 27).

S149: In response to the user pressing the information display button 225, the transmission/reception unit 11 of the terminal device 10 transmits a notification that the information display button 225 has been pressed, information for identifying the article, and the input information to the image management server 40. The transmission/reception unit 41 of the image management server 40 receives the notification, the information for identifying the article, and the input information. The determination unit 48 determines which of the first tacit knowledge model 4004A and the second tacit knowledge model 4004B is to be used to generate text information. Since the determination unit 48 determines that the login in step S141 is not a login using the image request program distributed from the conference management server 20, the determination unit 48 determines to use the second tacit knowledge model 4004B to generate text information.

The processing unit 47 requests the text information generation unit 45 to generate text information. The text information generation unit 45 acquires a tacit knowledge comment corresponding to the three-dimensional image information of the article from the second tacit knowledge model 4004B. The second tacit knowledge model 4004B can extract features of the three-dimensional image information of the article and identify input information corresponding to the features as a tacit knowledge comment.

S150: Subsequently, the text information generation unit 45 acquires text information created by the large language model 4005 using the tacit knowledge comment and the question sentence. The large language model 4005 can generate more detailed text information using the tacit knowledge comment and the question sentence. The text information generation unit 45 may convert voice information included in the input information into character information. The text information generated by the text information generation unit 45 may be either voice information or character information.

The text information generation unit 45 may generate text information without using any question sentences. Alternatively, the text information generation unit 45 may generate a fixed question within the information processing system 100 in advance and use the fixed question to generate text information. In this case, the question sentence is invisible to the user. Alternatively, the text information generation unit 45 may generate fixed questions within the information processing system 100 in advance, which are then displayed on the display unit to prompt the user to select any of the fixed questions, and use the selected question.

The processing unit 47 requests the screen generation unit 42 to generate a screen displaying the three-dimensional image information with the angle of view received in step S148 and the text information in association with each other. The screen generation unit 42 generates a screen corresponding to the second display area 215 for displaying the three-dimensional image information and the generated text information.

S151: The transmission/reception unit 41 of the image management server 40 transmits the generated text information to the terminal device 10 together with screen information of an image display screen 370. The transmission/reception unit 11 of the terminal device 10 receives the screen information of the image display screen 370 and the text information transmitted from the image management server 40.

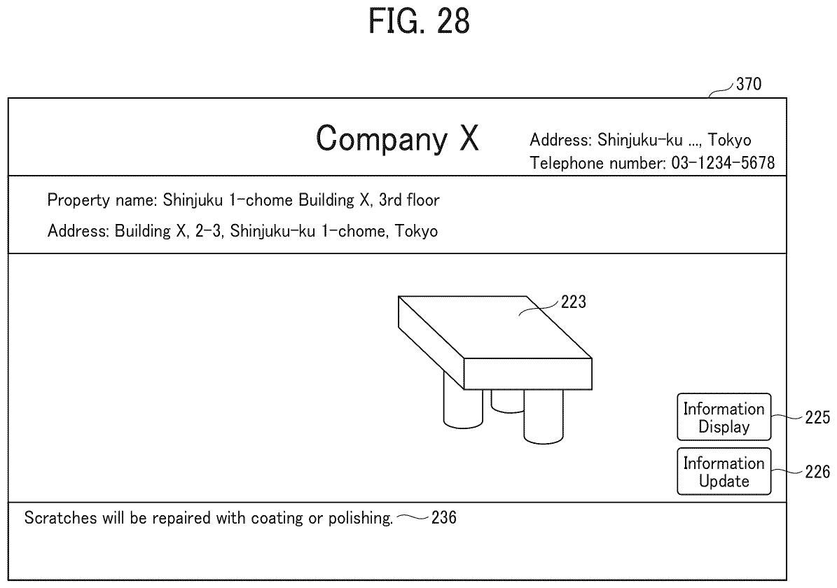

S152: The display control unit 13 of the terminal device 10 displays the image display screen 370 (see FIG. 28) including the text information. Alternatively, the conversion unit 15 converts the received text information into voice information, and the audio control unit 14 controls the speaker 109a to reproduce the converted text information. When the received text information is voice information, the text information is reproduced by the speaker 109a, or the conversion unit 15 converts the received text information into character information and the display 106a displays the converted text information.

### Example Screens in Inference Phase

Of the screens to be displayed on the terminal device 10 in the inference phase, the property designation screen 200 may be similar to that illustrated in FIG. 11, and the speech text display screen 210 illustrated in FIG. 12 is not displayed. In contrast, in place of the image display screen 220 illustrated in FIG. 13, a screen as illustrated in FIG. 27 is displayed.

FIG. 27 illustrates an example of an image display screen 360 in the inference phase. The image display screen 360 illustrated in FIG. 27 has substantially the same configuration as the image display screen 340 illustrated in FIG. 22, except that speech text is not displayed. This is because the terminal device 10 has not logged in to the conference management server 20. Also, the capture-generated image 237 is not displayed in FIG. 27. This is because the speech text 217 has not been selected. The user enters the question sentence 234, and presses the information display button 225 to make a request to generate text information using a tacit knowledge model. Accordingly, the text information generation unit 45 generates text information using the second tacit knowledge model 4004B and the large language model 4005.

The screen as illustrated in FIG. 27 on which speech text is not displayed and the three-dimensional image information 222 of the property is displayed is an example of a second display screen.

FIG. 28 illustrates an example of the image display screen 370 including text information. The image display screen 370 further includes text information 236. The text information 236 states, “Scratches will be repaired with coating or polishing”. The text information 236 is generated by the large language model 4005, based on the tacit knowledge comment generated by the second tacit knowledge model 4004B and the input information (question sentence). Thus, even when the article actually has a scratch, the actual scratch is not reflected in the tacit knowledge comment (information on the scratch included in the question sentence is reflected in the tacit knowledge comment). In addition, the large language model 4005 does not use past text to generate text information.

Accordingly, when the text information 236 illustrated in FIG. 28 is compared with the text information 235 illustrated in FIG. 23, the text information 236 is general text information regarding scratches on a table and is less detailed than the text information 235. However, the text information 236 has higher versatility with respect to scratches on a table.

Example in which Image Management Server Acquires Past Text from Conference Management Server

In FIGS. 18 and 21, the image management server 40 acquires, from the terminal device 10, the past text acquired by the terminal device 10 from the conference management server 20. However, the image management server 40 may acquire the past text directly from the conference management server 20.

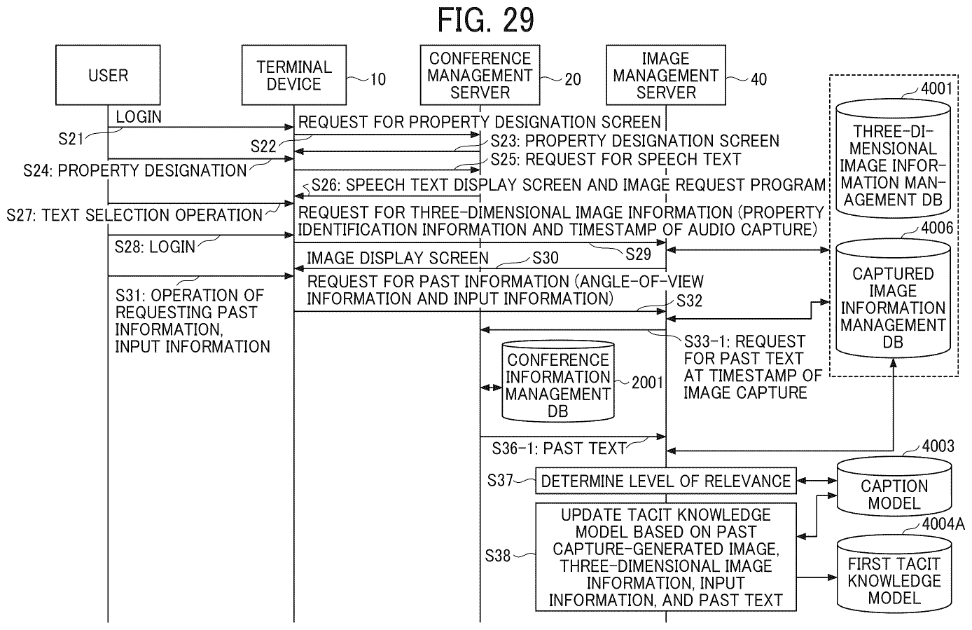

FIG. 29 is a sequence diagram illustrating an example of a process in which the image management server 40 updates a model through communication with the conference management server 20. While differences from FIG. 18 will be described with reference to FIG. 29, the sequence diagram of FIG. 21 is also modified in a similar manner. The processing of steps S21 to S32 may be similar to that in FIG. 18.

S33-1: The transmission/reception unit 41 of the image management server 40 receives the request for past information. The processing of step S33-1 is similar to that of step S33 in FIG. 18, except some differences. The differences include that the processing unit 47 requests the transmission/reception unit 41 to acquire speech text. By calling an API of the conference management server 20, the transmission/reception unit 41 transmits a request for speech text at the timestamp of image capture to the conference management server 20.

S36-1: The transmission/reception unit 21 of the conference management server 20 receives the request for speech text at the timestamp of image capture. The storing/reading unit 29 searches the conference information management DB 2001 for a timestamp of audio capture by using the received timestamp of image capture. The storing/reading unit 29 acquires, from the conference information management DB 2001, the speech text at the corresponding timestamp (image capturing device) and the speech text at the corresponding timestamp (communication terminal) associated with a timestamp of audio capture that is the same as or the closest to the timestamp of image capture. Such speech text is hereinafter referred to as past text (an example of second text data). The transmission/reception unit 21 transmits the acquired past text to the image management server 40.

The subsequent processing may be similar to that in FIG. 18. In FIG. 29, the process in which the image management server 40 acquires past text from the conference management server 20 is described using, as an example, the sequence diagram for model update. The same applies to the case of text information generation illustrated in FIG. 21.

Criterion for Determining Server to which User Logs In

The text information obtained by the user is different depending on to which of the image management server 40 and the conference management server 20 the user logs in. A determination criterion for determining to which of the image management server 40 and the conference management server 20 the user logs in will be described.

As described above, the first tacit knowledge model 4004A and the second tacit knowledge model 4004B have the following differences.

The first tacit knowledge model 4004A can generate text information specialized for expert knowledge and a specific article.

The second tacit knowledge model 4004B can generate general-purpose text information applicable to expert knowledge and articles of the same kind (or the same category) in general.

For example, the specific article is a centrifugal chiller used by a customer. In this case, the inspection history and the know-how of the article, which is owned by the customer, have been accumulated. The user determines to use the accumulated information and the first tacit knowledge model 4004A to generate accurate text information (e.g., an answer) specialized for the specific article.

Although such accurate information is not found for articles of the same type in general (refrigerators in the category of centrifugal chillers), there is expertise related to the general centrifugal chillers. In this case, accordingly, it is considered that the user uses the second tacit knowledge model 4004B to generate general-purpose text information (e.g., an answer) applicable to articles of the same kind in general. As described above, the user can determine whether to use past text to generate text information, based on the degree of detail of information to be used.

The determination unit 48, rather than the user, may determine whether to use past text to generate text information, automatically (without confirming with the user) or semi-automatically (by recommending to the user and requesting confirmation). For example, when a question sentence included in input information (voice and/or characters) is related to an article, the determination unit 48 determines to use the first tacit knowledge model 4004A because the second tacit knowledge model 4004B may fail to generate appropriate text information.

The number of types of tacit knowledge models is not limited to two and may be three or more, and the user may select a desired tacit knowledge model.

### Multimodal Models

Some examples of combinations of input information and tacit knowledge comments will be described. The model described above is assumed to be a large language model. However, the present embodiment may use a multimodal model that receives a plurality of data formats (e.g., image, text, and gesture) as input and outputs a predetermined data format.

Case where the input information is a character string and content other than text information is generated as a tacit knowledge comment

A character string is input, and an image is generated. A character string is input, and a moving image is generated. A character string is input, and a voice is generated. A character string is input, and a 3D model is generated.

Case where the input information includes a character string and non-character string information and text information is generated as a tacit knowledge comment

An image and a character string are input, and text information is generated. A 3D model and a character string are input, and text information is generated. A voice and a character string are input, and text information is generated.

Case where the input information includes a character string and non-character string information and content other than text information is generated as a tacit knowledge comment

An image and a character string are input, and an image is generated. A moving image and a character string are input, and a moving image is generated. A 3D model and a character string are input, and a 3D model is generated. A voice and a character string are input, and a voice is generated.

The present embodiment enables the image management server 40 to selectively use the first tacit knowledge model 4004A, which is trained on past text, and the second tacit knowledge model 4004B, which is trained without using past text. That is, a user who has logged in to the image management server 40 via the conference management server 20 can use the first tacit knowledge model 4004A to generate detailed text information, and a user who has logged in directly to the image management server 40 can use the second tacit knowledge model 4004B to generate text information having high versatility.

### Third Embodiment

A third embodiment of the present disclosure describes the information processing system 100 in which the image management server 40 performs a simulation. The simulation is a function achievable by the image management server 40 but not provided while the terminal device 10 is being connected to the conference management server 20.

In the present embodiment, reference is also made to the hardware configuration diagram of FIG. 2 and the functional block diagram of FIG. 3, which have been described in the first embodiment.

### Operations or Processes

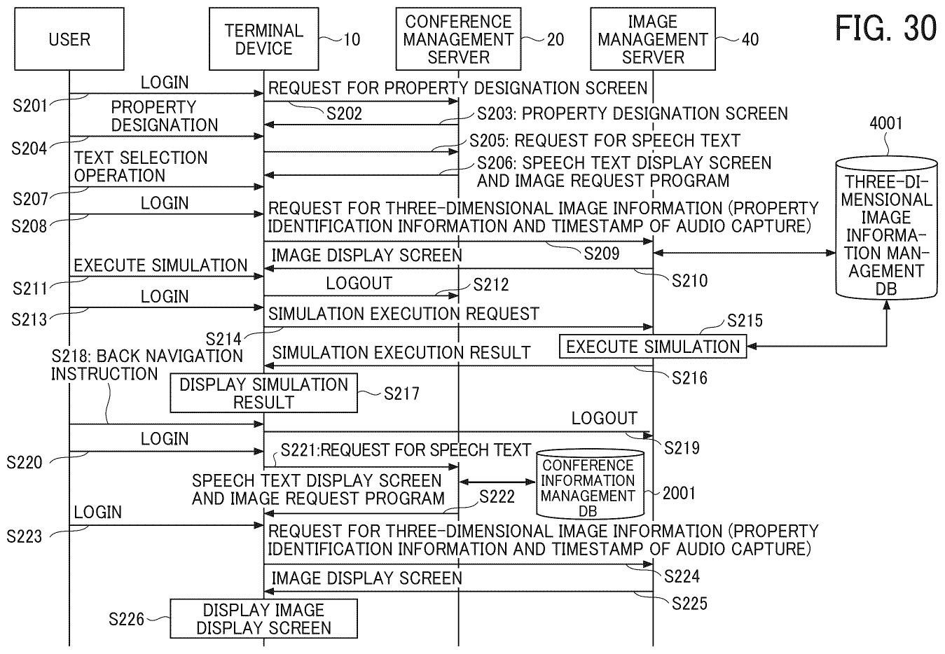

FIG. 30 is a sequence diagram illustrating an example of a process in which the image management server 40 performs a simulation. The processing of steps S201 to S210 may be similar to that of steps S1 to S10 in FIG. 10.

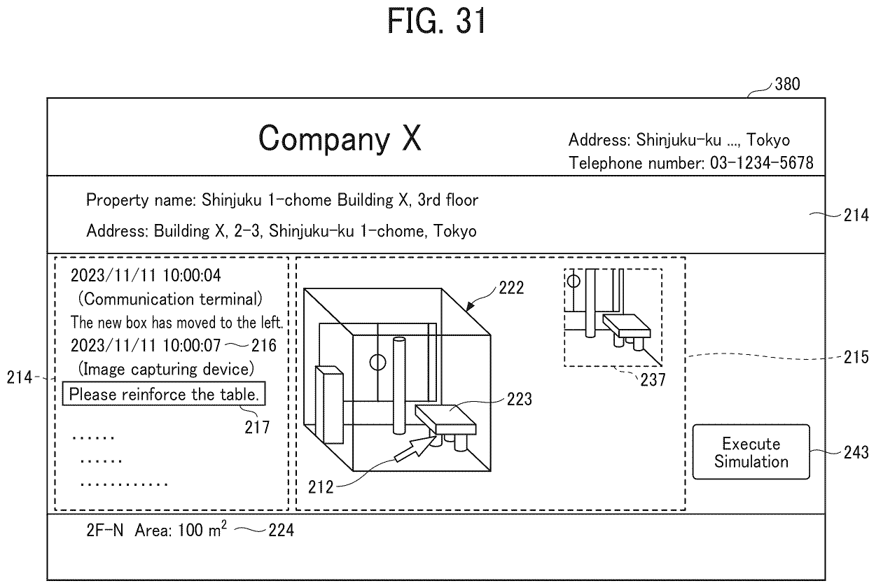

S211: The transmission/reception unit 11 of the terminal device 10 receives screen information of an image display screen 380, and the display control unit 13 displays the image display screen 380 (see FIG. 31). The user presses an “Execute Simulation” button 243 to perform a simulation related to a property or an article. The input reception unit 12 accepts the pressing of the “Execute Simulation” button 243.

S212: Since the simulation is a function of the image management server 40, the transmission/reception unit 11 logs out of the conference management server 20. This is because the image management server 40 performs a simulation while the user remains logged in to the image management server 40.

S213: Subsequently, the user inputs a login operation to the terminal device 10. The image request program preferably prompts the user to log in to the image management server 40. This login is to log in to the image management server 40. The input reception unit 12 of the terminal device 10 accepts the login operation. Any existing method may be used to perform the login. The following description is given on the assumption that the login is successful. Since the user has already logged in to the image management server 40 in step S208, the login in step S213 may be omitted.

S214: In response to a successful login, the transmission/reception unit 11 of the terminal device 10 transmits a simulation execution request to the image management server 40. Since the terminal device 10 logs in to the conference management server 20 later, the transmission/reception unit 11 may transmit, for example, the URL of the conference management server 20 to the image management server 40 for redirection.

S215: The transmission/reception unit 41 of the image management server 40 receives the simulation execution request. The simulation unit 52 performs a simulation. Any simulation may be performed. All of the simulations executable by the image management server 40 may be performed, or a simulation to be performed may be designated by the user.

S216: The screen generation unit 42 of the image management server 40 generates a simulation result screen 390, and the transmission/reception unit 41 of the image management server 40 transmits screen information of the simulation result screen 390 to the terminal device 10.

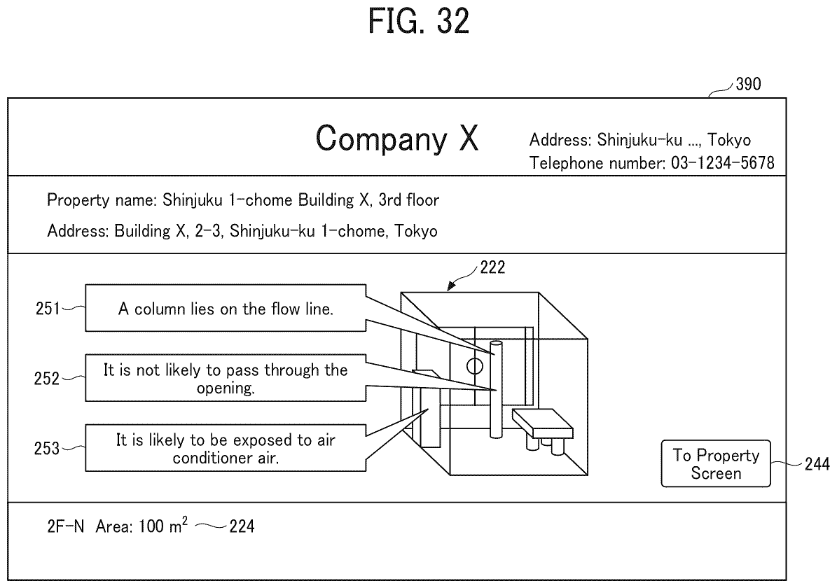

S217: The transmission/reception unit 11 of the terminal device 10 receives the screen information of the simulation result screen 390, and the display control unit 13 displays the simulation result screen 390 (see FIG. 32).

S218: After the completion of the simulation, the user inputs a back navigation instruction to the terminal device 10 to display the image display screen 380. The input reception unit 12 receives the input.

S219: The transmission/reception unit 11 logs out of the image management server 40 to connect the terminal device 10 to the conference management server 20.

S220: The user inputs a login operation to the terminal device 10. This login is to log in to the conference management server 20. The input reception unit 12 of the terminal device 10 accepts the login operation. Any existing method may be used to perform the login. The following description is given on the assumption that the login is successful. Since the terminal device 10 logs in to the image management server 40 later, the transmission/reception unit 11 may transmit, for example, the URL of the image management server 40 to the conference management server 20 for redirection.

S221: The transmission/reception unit 11 of the terminal device 10 transmits a request for speech text to the conference management server 20.

S222: The transmission/reception unit 21 of the conference management server 20 receives the request for speech text, and the storing/reading unit 29 searches the conference information management DB 2001 using the property identification information. The screen generation unit 22 of the conference management server 20 generates the speech text display screen 210 (see FIG. 12) for displaying speech text, and the transmission/reception unit 21 transmits screen information of the speech text display screen 210 to the terminal device 10.

In response to the request for speech text, the transmission/reception unit 21 also transmits an image request program to the terminal device 10 so that the terminal device 10 can acquire three-dimensional image information.

The transmission/reception unit 11 of the terminal device 10 receives the screen information of the speech text display screen 210 and the image request program. The display control unit 13 displays the speech text display screen 210. As a result, speech text is displayed.

S223: The user inputs a login operation to the terminal device 10. The image request program preferably prompts the user to log in to the image management server 40. This login is to log in to the image management server 40. The input reception unit 12 of the terminal device 10 accepts the login operation. The login operation may be omitted using, for example, single sign-on.

S224: Since the three-dimensional image information of the property has been displayed previously, the transmission/reception unit 11 of the terminal device 10 can designate the property identification information of the property and transmit a request for the three-dimensional image information of the property to the image management server 40 without causing the user to perform an operation of requesting the three-dimensional image information of the property. However, the user may designate the property identification information again. The transmission/reception unit 11 may also transmit the speech text acquired from the conference management server 20 to the image management server 40. This is because the image management server 40 causes the terminal device 10 to display the speech text and the three-dimensional image information of the property on a single screen.

The terminal device 10 executes the image request program to request three-dimensional image information. Accordingly, the transmission/reception unit 11 designates the property identification information of the property selected by the user and the timestamp of audio capture and transmits a request for a capture-generated image and three-dimensional image information of the property to the image management server 40.

S225: The transmission/reception unit 41 of the image management server 40 receives the request for a capture-generated image and three-dimensional image information of the property. The storing/reading unit 49 searches the three-dimensional image information management DB 4001 using the property identification information and acquires three-dimensional image information of each article. The storing/reading unit 49 further searches the captured image information management DB 4006 using the property identification information and acquires a capture-generated image (an example of a two-dimensional image) associated with the timestamp of image capture closest to the timestamp of audio capture, position information, and angle-of-view information. The processing unit 47 requests the screen generation unit 42 to generate a screen including the capture-generated image and the three-dimensional image information of the property. The screen generation unit 42 generates three-dimensional image information by placing a virtual camera at a position indicated by the position information and determining the angle of view of the virtual camera based on the angle-of-view information. As a result, the three-dimensional image information has the same angle of view as the capture-generated image. The screen generation unit 42 generates a screen corresponding to the second display area 215 in which the capture-generated image and the three-dimensional image information of each article are arranged on one screen.

The transmission/reception unit 41 transmits screen information of the image display screen 380 to the terminal device 10. The three-dimensional image information of each article is three-dimensional image information in which all the articles included in the property are placed in the property, and the user can change the point of view as desired.

S226: The transmission/reception unit 11 of the terminal device 10 receives the screen information of the image display screen 380, and the display control unit 13 displays the image display screen 380 (see FIG. 31).

### Example Screens

FIG. 31 illustrates an example of the image display screen 380 according to the present embodiment. In the description of FIG. 31, differences from FIG. 20 will be described. The image display screen 380 illustrated in FIG. 31 includes the “Execute Simulation” button 243. The input information (the question sentence 241) has not been entered. In response to the user pressing the “Execute Simulation” button 243, the image management server 40 performs a simulation.

The screen as illustrated in FIG. 31 on which speech text and the three-dimensional image information 222 of the property are displayed is an example of a first display screen.

FIG. 32 illustrates an example of the simulation result screen 390. The simulation result screen 390 displays the result of the simulation performed on the three-dimensional image information 222 of the property. Speech text is not displayed on the simulation result screen 390. This is because the terminal device 10 has logged in directly to the image management server 40.

While three simulation results 251, 252, and 253 are displayed in FIG. 32, three simulation results are merely an example. For example, the simulation result 251 provides an alert indicating a column, stating: “A column lies on the flow line”. The simulation result 252 provides an alert indicating the column, stating: “It is not likely to pass through the opening”. The simulation result 253 provides an alert indicating a storage box, stating: “It is likely to be exposed to air conditioner air”.

The simulation result screen 390 further includes a back button 244 for returning to the image display screen 380. The pressing of the back button 244 for returning to the image display screen 380 corresponds to the back navigation instruction. By pressing the back button 244 for returning to the image display screen 380, the user can make a transition to the image display screen 380 illustrated in FIG. 31.

The screen as illustrated in FIG. 32 on which speech text is not displayed and the three-dimensional image information 222 of the property is displayed is an example of a second display screen.

In the present embodiment, when a user performs a function unique to the image management server 40, such as a simulation function, the terminal device 10 logs out of the conference management server 20 and logs in to the image management server 40. Accordingly, the function of the image management server 40 can be provided to the user while the user remains logged in to the image management server 40.

### Fourth Embodiment

A fourth embodiment of the present disclosure describes the image management server 40 that generates an image from a captured image and text information.

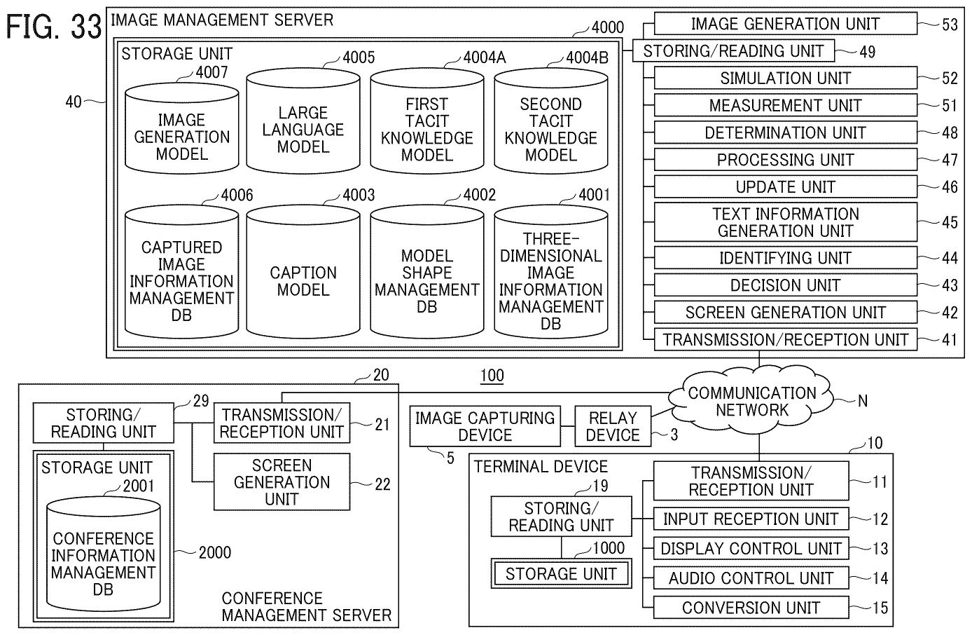

FIG. 33 is a diagram illustrating a functional configuration of an example of functions of the image management server 40, the conference management server 20, and the terminal device 10 in the information processing system 100 according to the present embodiment. In the description of FIG. 33, differences from FIG. 3 will be described.

The image management server 40 illustrated in FIG. 33 further includes an image generation unit 53, and the storage unit 4000 of the image management server 40 further includes an image generation model 4007. The other elements may be the same as those in FIG. 3.

The image generation unit 53 is an example of image generation means and is implemented by instructions from the CPU 401 illustrated in FIG. 2. The image generation unit 53 inputs text data to the image generation model 4007 or inputs text data and an image to the image generation model 4007 to generate image information.

The image generation model 4007 is a machine learning model (generative AI) that generates an image from text data or from text data and an image. The image generation model 4007 is trained using, for example, training data including text data and images. The training data includes, for example, text data or text data and an image for learning as input, and an image as ground truth for output. For example, the image generation model 4007 may be trained such that an image generated by the image generation model 4007 that has received text data or text data and an image included in training data as input becomes close to an image as ground truth included in the training data.

### Learning Phase

The processing in the learning phase may be similar to that illustrated in FIG. 18. In step S38, the update unit 46 updates the first tacit knowledge model 4004A so as to train the first tacit knowledge model 4004A to learn a correspondence between inputs representing a comment and past text determined to have a low level of relevance in step S37 and an output representing the past capture-generated image or the three-dimensional image information of the article. Alternatively, the update unit 46 updates the first tacit knowledge model 4004A so as to train the first tacit knowledge model 4004A to learn a correspondence between inputs representing the comment, the past text, and the three-dimensional image information (or the captured image) of the article and an output representing the past capture-generated image (or the three-dimensional image information).

### Inference Phase (Text Information Generation)

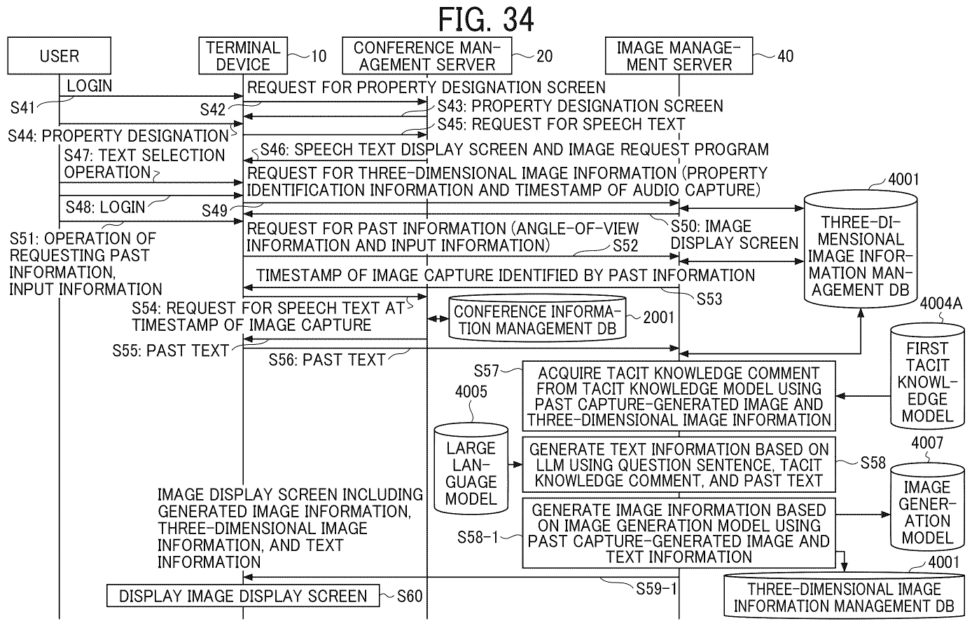

FIG. 34 is a sequence diagram illustrating an example of a process of generating text information and image information. In the description of FIG. 34, differences from FIG. 21 may be described. In FIG. 34, step S58-1 is further included.

S58-1: The image generation unit 53 inputs the past capture-generated image and the text information created by the large language model 4005 to the image generation model 4007 to generate image information. The image generation unit 53 may use the text information created by the large language model 4005, without using the past capture-generated image, to acquire the image information created by the image generation model 4007.

The storing/reading unit 49 stores the text information created by the large language model 4005 and the image information created by the image generation model 4007 in the three-dimensional image information management DB 4001 (or overwrites the information stored in the three-dimensional image information management DB 4001 with the text information created by the large language model 4005 and the image information created by the image generation model 4007) in association with the past text stored in the three-dimensional image information management DB 4001 in step S56.

S59-1: The processing unit 47 requests the screen generation unit 42 to generate a screen displaying the three-dimensional image information of the article corresponding to the model ID (received in step S52), the generated image information, and the text information in association with one another. The screen generation unit 42 generates a screen corresponding to the second display area 215 for displaying the three-dimensional image information of the article, the generated image information, and the text information. The transmission/reception unit 41 of the image management server 40 transmits screen information of the screen corresponding to the second display area 215 to the terminal device 10. The transmission/reception unit 11 of the terminal device 10 receives the screen information of the screen corresponding to the second display area 215 transmitted from the image management server 40.

### Example Screen in Inference Phase

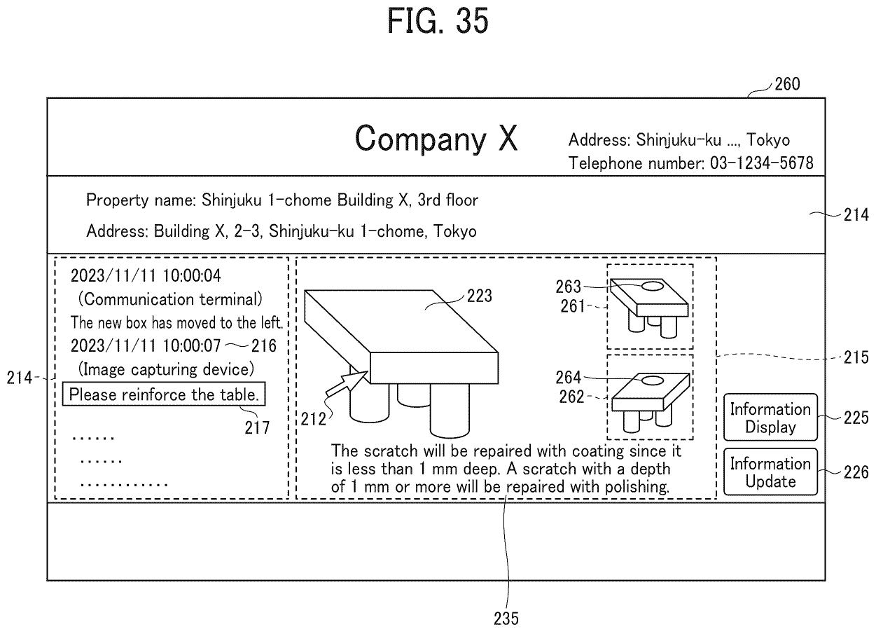

FIG. 35 is a diagram illustrating an example of generated image information displayed on an image display screen 260. In the description of FIG. 35, differences from FIG. 23 will be described.

The image display screen 260 illustrated in FIG. 35 displays generated images 261 and 262. The generated images 261 and 262 are not identical to the capture-generated image 237 and a past capture-generated image 238, which are illustrated in FIG. 23, but are generated by the image generation model 4007 based on the past capture-generated image 238 and the text information 235. Thus, the generated images 261 and 262 include markers 263 and 264 indicating the positions of a scratch, respectively. One of the generated images 261 and 262 may be the past capture-generated image 238, or the generated images 261 and 262 may be displayed in a switchable manner in response to a user operation.

As described above, the image management server 40 can generate image information using a past capture-generated image and text information, based on the image generation model 4007.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. The image management server 40 described in the embodiments described above is an example, and various example system configurations are applicable depending on the application or the purpose.

For example, the embodiments described above illustrate an example in which a tacit knowledge model for an industry such as civil engineering or architecture answers a question. However, the tacit knowledge model may be used in any industry in which tacit knowledge is effective, such as medical care, dental care, or investment decision-making.

In the embodiments described above, furthermore, the large language model 4005 generates text information based on a tacit knowledge comment. In another example, the large language model 4005 is not used, and a tacit knowledge comment may be used as text information.

The first tacit knowledge model 4004A may be trained on tacit knowledge comments using three-dimensional image information and past text as input and input information as output. That is, different forms of information, such as images and text, may be used as input.

The image management server 40 may generate two items of text information using both the first tacit knowledge model 4004A and the second tacit knowledge model 4004B, rather than either of them. That is, the image management server 40 generates text information using at least one of the first tacit knowledge model 4004A and the second tacit knowledge model 4004B.

In the embodiments described above, furthermore, the information processing system 100 is a client-server system. However, the functions of the image management server 40 may be installed in the terminal device 10 as an application. That is, the user may be allowed to use the functions illustrated in the embodiments described above in a stand-alone manner.

In the example configurations such as the example configuration illustrated in FIG. 3, each configuration is divided according to main functions to facilitate understanding of processing performed by the image management server 40. No limitation on the present disclosure is intended by how the functions are divided by process or by the name of the functions. The processing of the image management server 40 may be divided into more processing units in accordance with the content of the processing. In addition, the division may be performed so that one processing unit contains more processes.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in one or more embodiments are just one example of plural computing environments that implement the one or more embodiments disclosed herein. In some embodiments, the image management server 40 includes multiple computing devices, such as a server cluster. The multiple computing devices communicate with one another through any type of communication link including a network, shared memory, or the like and perform the processes disclosed herein.

Further, the image management server 40 may perform the processing steps disclosed herein in various combinations. The components of the image management server 40 may be integrated into one apparatus or divided into a plurality of apparatuses. The processes performed by the image management server 40 may be performed by the terminal device 10.

The present disclosure includes the following aspects.

In Aspect 1, an information processing system includes a first server, a second server, and a terminal device communicable with the first server and the second server. The first server manages speech text based on audio data obtained in response to a captured image of a target object being obtained by an image capturing device. The second server manages three-dimensional image information of the target object and the captured image aligned in position with the three-dimensional image information. The terminal device includes a display control unit. The display control unit displays a first display screen. The first display screen includes the speech text, which is received from the first server during a session established between the terminal device and the first server, and the three-dimensional image information and the captured image, which are received from the second server during a session established between the terminal device and the second server in a case where the terminal device has established a session with the first server. The display control unit displays a second display screen. The second display screen includes the three-dimensional image information and the captured image, which are received from the second server during a session established between the terminal device and the second server. The second server includes a processing unit. The processing unit performs processing based on the three-dimensional image information and input information received by an input reception unit of the terminal device through the first display screen, or processing based on the three-dimensional image information and input information received by the input reception unit of the terminal device through the second display screen.

According to Aspect 2, in the information processing system of Aspect 1, the display control unit displays, on the first display screen, a result of processing performed by the processing unit based on the three-dimensional image information and the input information received by the input reception unit through the first display screen, and displays, on the second display screen, a result of processing performed by the processing unit based on the three-dimensional image information and the input information received by the input reception unit through the second display screen.

According to Aspect 3, in the information processing system of Aspect 2, the processing unit measures a distance between two points received by the input reception unit with respect to the three-dimensional image information displayed on the first display screen, and the processing unit measures a distance between two points designated in the input information with respect to the three-dimensional image information displayed on the second display screen.

According to Aspect 4, in the information processing system of Aspect 2, the processing unit identifies the captured image based on an angle of view of the three-dimensional image information for which selection is accepted by the terminal device, acquires, from the first server, the speech text obtained in response to the captured image being obtained, and performs processing for associating the speech text transmitted from the first server with the three-dimensional image information, or processing for associating the three-dimensional image information with generated information that is generated based on the speech text, and the display control unit displays, on the first display screen, the speech text and the three-dimensional image information associated with each other or the three-dimensional image information and the generated information associated with each other.

According to Aspect 5, in the information processing system of any one of Aspects 1 to 4, the second server identifies the captured image based on an angle of view of the three-dimensional image information for which selection is accepted by the terminal device, acquires, from the first server, the speech text obtained in response to the captured image being obtained, and further includes a first model, a second model, and a determination unit. The first model is trained on a correspondence between the three-dimensional image information and the speech text or a correspondence among the three-dimensional image information, the speech text, and input information input to the terminal device. The second model is trained on a correspondence between the three-dimensional image information and the input information input to the terminal device. The determination unit determines whether to generate text information related to the target object using the three-dimensional image information for which selection is accepted by the terminal device, the speech text, and the first model, or to generate text information related to the target object using the three-dimensional image information for which selection is accepted by the terminal device and the second model.

According to Aspect 6, in the information processing system of Aspect 5, the determination unit determines whether to use the first model or the second model, based on whether the terminal device has logged in directly to the second server or has logged in to the second server after logging in to the first server.

According to Aspect 7, in the information processing system of Aspect 5, the processing unit performs first processing based on the input information received by the input reception unit through the first display screen, the speech text acquired from the first server or acquired from the terminal device after the terminal device has acquired the speech text from the first server, and the three-dimensional image information.

According to Aspect 8, in the information processing system of Aspect 7, the first processing includes processing for generating the text information, based on the three-dimensional image information, the speech text, the input information received by the input reception unit through the first display screen, and the first model.

According to Aspect 9, in the information processing system of Aspect 8, the first processing further includes processing for updating the first model by training the first model to learn a correspondence among the three-dimensional image information, the speech text, and the input information received by the input reception unit through the first display screen.

According to Aspect 10, in the information processing system of Aspect 5, the processing unit performs second processing based on the input information received by the input reception unit through the second display screen and the three-dimensional image information.

According to Aspect 11, in the information processing system of Aspect 10, the second processing includes processing for generating the text information, based on the three-dimensional image information, the input information received by the input reception unit through the second display screen, and the second model.

According to Aspect 12, in the information processing system of Aspect 10, the second processing includes processing for updating the second model by training the second model to learn a correspondence between the three-dimensional image information and the input information received by the input reception unit through the second display screen.

According to Aspect 13, in the information processing system of Aspect 1, the processing unit performs third processing, based on the three-dimensional image information managed by the second server.

According to Aspect 14, in the information processing system of Aspect 13, the third processing includes processing for performing a simulation, based on the three-dimensional image information.

According to Aspect 15, in the information processing system of Aspect 14, in response to the input reception unit receiving a request to perform a simulation while the terminal device remains logged in to the first server, the terminal device logs out of the first server, and logs in to the second server to request the second server to perform the simulation.

According to Aspect 16, in the information processing system of any one of Aspects 1 to 15, the three-dimensional image information includes a two-dimensional projected representation of a three-dimensional model shape of the target object, and is displayable with varying points of view.

1. An information processing system comprising:
a first server including first circuitry configured to manage speech text based on audio data obtained with a captured image of a target object;
a second server including second circuitry configured to manage three-dimensional image information of the target object and the captured image that is aligned in position with the three-dimensional image information; and
a terminal device communicable with the first server and the second server,
the terminal device including terminal circuitry configured to:
display a first display screen on a display, the first display screen including the speech text, the three-dimensional image information, and the captured image, the speech text being received from the first server during a session established between the terminal device and the first server, the three-dimensional image information and the captured image being received from the second server during a session established between the terminal device and the second server in a case where the terminal device has established a session with the first server; and
display a second display screen on the display, the second display screen including the three-dimensional image information and the captured image, the three-dimensional image information and the captured image being received from the second server during a session established between the terminal device and the second server,
the second circuitry being configured to
perform processing based on the three-dimensional image information and input information received by the terminal device through the first display screen or the second display screen.

2. The information processing system according to claim 1, wherein
the terminal circuitry is configured to:
in a case where the input information and the three-dimensional image information are received through the first display screen, display, on the first display screen, a result of processing performed based on the three-dimensional image information and the input information received through the first display screen; and
in a case where the input information and the three-dimensional image information are received through the second display screen, display, on the second display screen, a result of processing performed based on the three-dimensional image information and the input information received through the second display screen.

3. The information processing system according to claim 2, wherein
the second circuitry is configured to measure a distance between two points for the three-dimensional image information, the two point being input through the first display screen or the second display screen.

4. The information processing system according to claim 2, wherein
the second circuitry is configured to:
identify the captured image based on an angle of view of the three-dimensional image information that is selected by the terminal device;
acquire, from the first server, the speech text of the captured image;
associate the speech text and the three-dimensional image information with each other; and
display the speech text and the three-dimensional image information associated with each other on the first display screen.

5. The information processing system according to claim 2, wherein
the second circuitry is configured to:
identify the captured image based on an angle of view of the three-dimensional image information that is selected by the terminal device;
acquire, from the first server, the speech text of the captured image;
associate the three-dimensional image information and generated information with each other, the generated information being generated based on the speech text; and
display the three-dimensional image information and the generated information associated with each other on the first display screen.

6. The information processing system according to claim 1, wherein
the second circuitry is configured to:
identify the captured image based on an angle of view of the three-dimensional image information that is selected by the terminal device;
acquire, from the first server, the speech text of the captured image; and
determine whether to generate text information related to the target object using the three-dimensional image information, the speech text, and a first model, or to generate text information related to the target object using the three-dimensional image information and a second model,
the first model being trained on a correspondence between the three-dimensional image information and the speech text, and
the second model being trained on a correspondence between the three-dimensional image information and input information input to the terminal device.

7. The information processing system according to claim 6, wherein
the first model is trained on a correspondence between the three-dimensional image information, the speech text, and the input information input to the terminal device.

8. The information processing system according to claim 7, wherein
the second circuitry is configured to determine whether to use the first model or the second model, based on whether the terminal device has logged in directly to the second server or has logged in to the second server after logging in to the first server.

9. The information processing system according to claim 7, wherein
the second circuitry is configured to, in a case where the input information and the three-dimensional image information are received through the first display screen, perform first processing based on the received input information, the speech text acquired from the first server, and the received three-dimensional image information.

10. The information processing system according to claim 9, wherein
the first processing includes processing for generating text information related to the target object, based on the input information, the speech text, the three-dimensional image information, and the first model.

11. The information processing system according to claim 10, wherein
the first processing further includes processing for updating the first model by training the first model to learn the correspondence between the input information, the speech text, and the three-dimensional image information.

12. The information processing system according to claim 7, wherein
the second circuitry is configured to, in a case where the input information and the three-dimensional image information are received through the second display screen, perform second processing based on the received input information and the received three-dimensional image information.

13. The information processing system according to claim 12, wherein
the second processing includes processing for generating text information related to the target object, based on the input information, the three-dimensional image information, and the second model.

14. The information processing system according to claim 12, wherein
the second processing further includes processing for updating the second model by training the second model to learn the correspondence between the input information and the three-dimensional image information.

15. The information processing system according to claim 1, wherein
the second circuitry is configured to perform third processing, based on the three-dimensional image information managed by the second server.

16. The information processing system according to claim 15, wherein
the third processing includes processing for performing a simulation, based on the three-dimensional image information.

17. The information processing system according to claim 16, wherein
in response to receiving a request to perform a simulation while the terminal device remains logged in to the first server,
the terminal circuitry is configured to:
log the terminal device out of the first server; and
log the terminal device into the second server to request the second server to perform the simulation.

18. The information processing system according to claim 1, wherein
the three-dimensional image information includes a two-dimensional projected representation of a three-dimensional model shape of the target object, and is displayable with varying points of view.

19. A second server communicable with a terminal device and a first server that manages speech text based on audio data obtained with a captured image of a target object, the second server comprising circuitry configured to:
manage three-dimensional image information of the target object and the captured image that is aligned in position with the three-dimensional image information; and
perform processing based on the three-dimensional image information and input information received by the terminal device through a first display screen or a second display screen,
the first display screen including the speech text, the three-dimensional image information, and the captured image,
the speech text being received by the terminal device from the first server during a session established with the first server,
the three-dimensional image information and the captured image being received by the terminal device from the second server during a session established with the second server in a case where the terminal device has established a session with the first server,
the second display screen including the three-dimensional image information and the captured image,
the three-dimensional image information and the captured image being received by the terminal device from the second server during a session established with the second server.

20. A non-transitory recording medium storing a plurality of instructions which, when executed by one or more processors on a second server communicably connected with a terminal device and a first server, causes the one or more processors to perform an information processing method comprising:
managing three-dimensional image information of a target object and a captured image of the target object, the captured image being aligned in position with the three-dimensional image information; and
performing processing based on the three-dimensional image information and input information received by the terminal device through a first display screen or a second display screen,
the first display screen including speech text, the three-dimensional image information, and the captured image,
the speech text being received by the terminal device from the first server during a session established with the first server, the speech text being based on audio data obtained with the captured image,
the three-dimensional image information and the captured image being received by the terminal device from the second server during a session established with the second server in a case where the terminal device has established a session with the first server,
the second display screen including the three-dimensional image information and the captured image,
the three-dimensional image information and the captured image being received by the terminal device from the second server during a session established with the second server.
